(19) United States
(12) Patent Application Publication
(10) Pub. No.: US 2002/0078431 A1
(43) Pub. Date: Jun. 20, 2002

(54) Method for representing information in a highly compressed fashion

(76) Inventor: Thomas W. Reps, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 09/776,218

(22) Filed: Feb. 2, 2001

Related U.S. Application Data
(60) Provisional application No. 60/180,099, filed on Feb. 3, 2000.

(51) Int. Cl. G06F 9/44

(52) U.S. Cl. 717/100; 717/101

(57) ABSTRACT

CFLOBDDs are a new compressed representation of functions over Boolean-valued arguments. They provide an alternative to the now-standard representation provided by Ordered Binary Decision Diagrams (OBDDs) and Multi-Terminal Binary Decision Diagrams (MTBDDs) (also known as Algebraic Decision Diagrams (ADDs)). CFLOBDDs share many of the good properties of OBDDs and MTBDDs, but can lead to data structures of drastically smaller size—exponentially smaller than OBDDs and MTBDDs, in fact. That is, OBDDs and MTBDDs are data structures that—in the best case—yield an exponential reduction in the size of the representation of a function (i.e., compared with the size of the decision tree for the function). In contrast, a CFLOBDD—again, in the best case—yields a doubly exponential reduction in the size of the representation of a function. Obviously, not every function has such a highly compressed representation, but the potential advantage of CFLOBDDs over OBDDs and MTBDDs is that they can allow data (e.g., functions, matrices, graphs, relations, circuits, signals, etc.) to be stored in a much more compressed fashion. Application areas include, but are not limited to:

analysis, synthesis, optimization, simulation, test generation, timing analysis, and verification of hardware systems

analysis and verification of software systems use as a runtime data structure in software application programs

data compression and transmission of data in compressed form

spectral analysis and signal processing

use as a runtime data structure in solvers for integer-programming, network-flow, and genetic-programming problems In such applications, CFLOBDDs have the potential to

permit problems to be solved much faster, and

allow much larger problems to be attacked than has previously been possible.

### FIELD OF THE INVENTION

The present invention relates to the creation and manipulation of structures that can be used to represent and store certain kinds of information in a highly compressed fashion in the memory of a computer.¹ Examples of the kind of information to which these methods can be applied include both Boolean-valued and non-Boolean-valued functions over Boolean arguments, as well as other related kinds of information, such as matrices, graphs, relations, circuits, signals, etc. Application areas for these methods include, but are not limited to,

analysis, synthesis, optimization, simulation, test generation, timing analysis, and verification of hardware systems

analysis and verification of software systems

use as a runtime data structure in software application programs

data compression and transmission of data in compressed form

spectral analysis and signal processing

use as a runtime data structure in solvers for integer-programming, network-flow, and genetic-programming problems ¹ Throughout, we use the term “computer” as a generic term meaning riot only computing devices per se, but also communication devices and any other hardware devices that make use of, and manipulate the contents of, digital memories.

### BACKGROUND OF THE INVENTION

A great many tasks that are performed during the design, creation, analysis, validation, and verification of hardware and software systems—as well as in many other application areas—either directly involve operations on functions over Boolean arguments, or can be cast as operations on functions of that form that, encode the actual structures of interest. Examples of tasks in which such operations prove useful include: analysis, synthesis, optimization, simulation, test generation, timing analysis as part of computer-aided design of logic circuits; spectral analysis and signal processing; verification of digital hardware and/or software (using a variety of different approaches); and static analysis of computer programs.

To take just one example, consider one of the success stories of the last fifteen years in the detection of logical errors in hardware and software systems, namely, the development of the verification method called temporal logic model checking [CGP99], which was first formulated independently by Clarke and Emerson [CE81] and Quielle and Sifakis [QS81]. Model checking involves the use of logic to verify that such systems behave as they are supposed to, or, alternatively, to identify errors in such systems. In this approach, specifications of desired properties are expressed using a propositional temporal logic (e.g., LTL, CTL, CTL^{*}, or μ-calculus), and circuits and protocols are modeled as state-transition systems. A search procedure is used to determine whether a given property is satisfied by the given transition system. The search itself is turned into a problem of finding the fixed-point of a recursively defined relational-calculus expression. The fundamental problem that one faces in using model checking to verify properties of hardware or software systems is the enormous size of the state spaces that need to be explored. This is due to the so-called “state-explosion” problem: the size of the state space over which the search is carried out usually increases exponentially with the size of the description of the system.

The great innovation in model checking (due to Ken McMillan, c. 1990 [McM93]) was the recognition that the necessary Boolean operations could be done indirectly (i.e., symbolically) using Ordered Binary Decision Diagrams (OBDDs) [Bry86, BRB90, Weg00] to represent the structures that arise in the fixed-point-finding computation. That is, transition relations, sets of states, etc. are all encoded as Boolean functions; the Boolean functions are represented in compressed form as OBDD data structures; and all necessary manipulations of these Boolean functions are carried out using algorithms that operate on OBDDs.

Whereas methods based on explicit enumeration of states are limited to systems with at most 10⁸ reachable states, techniques based on OBDDs allow model checking to be applied to systems with as many as 10¹⁰⁰ reachable states. In the worst case, the data structures involved can explode in size (and may no longer fit in a computer's memory); however, in many cases, there turns out to be enough regularity to the Boolean functions being encoded via OBDDs that the structures involved stay of manageable size.

OBDDS

Roughly speaking, an OBDD is a data structure that—in the best case—yields an exponential reduction in the size of the representation of a Boolean function (i.e., compared with the size of the decision tree for the function). FIG. 1(b) shows the OBDD for the two-input function λx₀x₁.x₀.² An OBDD is based on the representation of a Boolean function as an ordered binary decision tree (cf. FIG. 1(a)); here the term “ordered” means that the input variables are totally ordered (e.g., in FIG. 1 the order is [x₀, x₁]). Given an assignment of values for the function's Boolean input variables (e.g., [x₀ [symbol] T, x₁ [symbol] T]), one works down from the root of the tree. Each ply of the tree handles the next variable in the ordering: The convention that we will follow in all of our diagrams is that one proceeds to the left if the variable has the value F; one proceeds to the right if the variable has the value T. The pointer at the leaf takes you to the value of the function on this assignment of input values. ² Because the ordering of variables is important, it is convenient to express functions using lambda notation (i.e., in the function λz.exp, z is the name of the formal parameter, and exp is the function body). For functions with multiple formal parameters, the parameters are listed in order after the λ; parameters may be optionally separated by commas. For instance, λx₀x₁.x₀ (or λx₀,x₁.x₀) denotes the two-argument function that merely returns its first argument.

An OBDD is a folded version of the binary decision tree in which substructures are shared as much as possible, which turns the tree into a directed acyclic graph (DAG). Evaluation of an OBDD is carried out in the same fashion as in the binary decision tree, but now one follows a path in the DAG.

When people speak of “BDDs” or “OBDDs” they often mean “Reduced OBDDs” (ROBDDs) [Bry86, BRB90]. In ROBDDs, an additional reduction transformation is performed, in which “don't-care” vertices are removed. For instance, the OBDD shown in FIG. 1(b) contains two don't-care vertices for x₁, that would be removed in the ROBDD for the function. We have chosen to illustrate the principles behind CFLOBDDs using OBDDs rather than ROBDDs because the family resemblances between OBDDs and CFLOBDDs are more apparent; the removal of don't-care vertices in an ROBDD obscures the resemblance to the corresponding CFLOBDD to some degree.

MTBDDS

Multi-Terminal Binary Decision Diagrams (MTBDDs) [CMZ⁺93, CFZ95a ], also known as Algebraic Decision Diagrams (ADDs) [BFG⁺93], are constructed similarly to OBDDs, except that they represent decision trees whose leaves are labeled with values drawn from some possibly non-Boolean value space. As in OBDDs, vertices in MTBDDs are shared to form a DAG; in particular, the number of terminal vertices in an MTBDD's DAG is the number of distinct values that label leaves of the decision tree being represented. Thus, an MTBDD represents a function from Boolean arguments to some space of, in general, non-Boolean results; OBDDs are the special case of Boolean-valued MTBDDs.

OBDDs and MTBDDs will be collectively referred to as BDDs when the distinction is unimportant.

REPRESENTING MATRICES WITH BDDS

Boolean matrices can be represented using OBDDs [Bry92]; non-Boolean matrices can be represented using MTBDDs [CMZ⁺93, CFZ95a]. In both cases, square matrices are represented by having the Boolean variables correspond to bit positions in the two array indices. That is, suppose that M is a 2ⁿ×2ⁿ matrix; M is represented using a BDD over 2n Boolean variables {x₀, x₁, . . . , xₙ₋₁}U {y₀, y₁, . . . , yₙ₋₁}, where the variables {x₀, x₁, . . . , xₙ₋₁}represents the successive bits of x—the first index into M—and the variables {y₀, y₁, . . . , yₙ₋₁} represent the successive bits of y—the second index into M. We will let F indicate a bit value of 0, and T represent a bit value of 1.³ ³ Matrices of other sizes, including non-square matrices, can be represented using BDDs; for instance, they can be embedded within a larger square matrix whose dimensions are of the form 2ⁿ×2²ⁿ. Matrices with mole than two dimensions can be represented by introducing a set of Booleani variables for the index-bits of each dimension.

Note that the indices of elements of matrices represented in this way start at 0; for example, the upper-left corner element of a matrix M is M(0, 0): When n=2, M(0, 0) corresponds to the value associated with the assignment [x₀ [symbol] F, x₁ [symbol] F, y₀ [symbol] F, y₁ [symbol] F].

It is often convenient to use either the interleaved ordering for the plies of the BDD—i.e., the order of the Boolean variables is chosen to be x₀, y₀, x₁, y₁, . . . , xₙ₋₁, yₙ₋₁—or the reverse interleaved ordering—i.e., the order is yₙ₋₁, xₙ₋, yₙ₋₂, yₙ₋₂, . . . ,y₀, x₀.

One nice property of the interleaved variable ordering is that, as we work through each pair of variables in an assignment, we arrive at a node of the OBDD that represents a sub-block of the full matrix. For instance, suppose that we have a Boolean matrix whose entries are defined by the function λx₀y₀x₁y₁.(x₀ [symbol] y₀ )V(x₁ [symbol] y₁), as shown below:

$$\begin{matrix}F & F & T & T & {y}_{0} \\ F & T & F & T & {y}_{1}\end{matrix}$$

$$\begin{matrix}F \\ F \\ T \\ T \\ {x}_{0}\end{matrix} \begin{matrix}F \\ T \\ F \\ T \\ {x}_{1}\end{matrix} \begin{matrix}\begin{matrix}F & F \\ F & T\end{matrix} \\ \begin{matrix}F & F \\ F & T\end{matrix}\end{matrix} \begin{matrix}\begin{matrix}F & F \\ F & T\end{matrix} \\ \begin{matrix}T & T \\ T & T\end{matrix}\end{matrix}$$

Under the interleaved variable ordering—x₀, y₀, x₁, y₁—a given pair of values for x₀ and y₀ leads us to an OBDD vertex that represents one of the four sub-blocks shown above. For instance, the partial assignment [x₀ [symbol] F, y₀ [symbol] T] corresponds to the upper right-hand block.

If we were to evaluate the 16 possible assignments in lexicographic order, i.e., in the order

$$\begin{matrix}\begin{matrix}[ {x}_{0} ↦ F , {y}_{0} ↦ F , {x}_{1} ↦ F , {y}_{1} ↦ F ] , \\ [ {x}_{0} ↦ F , {y}_{0} ↦ F , {x}_{1} ↦ F , {y}_{1} ↦ T ] , \\ [ {x}_{0} ↦ F , {y}_{0} ↦ F , {x}_{1} ↦ T , {y}_{1} ↦ F ] , \\ [ {x}_{0} ↦ F , {y}_{0} ↦ F , {x}_{1} ↦ T , {y}_{1} ↦ T ] , \\ [ {x}_{0} ↦ F , {y}_{0} ↦ T , {x}_{1} ↦ F , {y}_{1} ↦ F ] , \\ ⋮\end{matrix} \\ [ {x}_{0} ↦ T , {y}_{0} ↦ T , {x}_{1} ↦ T , {y}_{1} ↦ F ] , \\ [ {x}_{0} ↦ T , {y}_{0} ↦ T , {x}_{1} ↦ T , {y}_{1} ↦ T ]\end{matrix}$$

then we would step through the array elements in the order shown below:

$$\begin{matrix}F & F & T & T & {y}_{0} \\ F & T & F & T & {y}_{1}\end{matrix}$$

$$\begin{matrix}F \\ F \\ T \\ T \\ {x}_{0}\end{matrix} \begin{matrix}F \\ T \\ F \\ T \\ {x}_{1}\end{matrix} \begin{matrix}\begin{matrix}1 & 2 \\ 3 & 4\end{matrix} \\ \begin{matrix}9 & 10 \\ 11 & 12\end{matrix}\end{matrix} \begin{matrix}\begin{matrix}5 & 6 \\ 7 & 8\end{matrix} \\ \begin{matrix}13 & 14 \\ 15 & 16\end{matrix}\end{matrix}$$

LIMITATIONS

While there have been numerous successes obtained by means of BDDs (and BDD variants [SF96]) on a wide class of problems, there are limitations. For instance, the use of BDDs for problems such as model checking, equivalence checking for combinational circuits, and tautology checking seems to be limited to problems where the functions involve at most a few hundred Booleanl-valued arguments.

### SUMMARY OF THE INVENTION

The present invention concerns a new structure—and associated algorithms—for creating, storing, organizing, and manipulating certain kinds of information in a computer memory. In particular, this invention provides new ways for representing and manipulating functions over Boolean-valued arguments (as well as other related kinds of information, such as matrices, graphs, relations, circuits, signals, etc.), and serves as an alternative to BDDs. Wve call these structures CFLOBDDs. As with BDDs, there are Boolean-valued and multi-terminal variants of CFLOBDDs. We will use “CFLOBDD” to refer to both kinds of structures generically, “Boolean-valued CFLOBDDs” when we wish to stress that the structure under discussion represents a Boolean-valued function, and “multi-terminal CFLOBDDs” when we wish to stress the possibly non-Boolean nature of the values stored in the structure under discussion.

CFLOBDDs share many of the same good properties that BDDs possess, for instance,

One can perform many kinds of interesting operations directly on the data structure, without having to build the full decision tree.

Like BDDs, CFLOBDDs provide a canonical form for functions over Boolean-valued arguments, which means that standard techniques can be used to enforce the invariant that only a single representative is ever constructed for each different CFLOBDD value. This allows a test of whether two CFLOBDDs represent equal functions to be performed by comparing two pointers.

However, CFLOBDDs can lead to data structures of drastically smaller size than BDDs—exponentially smaller than BDDs, in fact. Among the objects that can be encoded in doubly-exponential compressed form using CFLOBDDs are projection functions, step functions, and integer matrices for some of the recursively defined spectral transforms, such as the Reed-Muller transform, the inverse Reed-Muller transform, the Walsh transform, and the Boolean Haar Wavelet transform [HMM85].

The bottom line is that this invention has the potential to

permit data (e.g., functions, matrices, graphs, relations, circuits, signals, etc.) to be stored in a much more compressed fashion,

permit applications to be performed much faster, and

allow much larger problems to be attacked than has previously been possible.

Moreover, CFLOBDDs are a plug-compatible replacement for BDDs: A set of subroutines that program a digital computer to implement these techniques can serve as a replacement component for the analogous components that, using different and less efficient methods, serve the same purpose in present-day systems. Thus, BDD-based applications should be able to exploit the advantages of CFLOBDDs with minimal reprogramming effort. Consequently, some of the possible application areas for CFLOBDDs include the ones in which BDDs have been previously applied with some success, which include

analysis, synthesis, optimization, simulation, test generation, timing analysis, and verification of hardware systems

analysis and verification of software systems

use as a runtime data structure in software application programs

data compression and transmission of data in compressed form

spectral analysis and signal processing

use as a runtime data structure in solvers for integer-programming, network-flow, and genetic-programming

However, the present invention provides a generally useful method for creating, storing, organizing, and manipulating certain kinds of information in a computer memory, and its use is not limited to just the applications listed above.

### BRIEF DESCRIPTION OF THE DRAWINGS

FIG. I compares the OBDD and CFLOBDD for the two-input function λx₀x₁.x₀. In each of FIGS. 1(c) and 1(f), the path corresponding to the assignment [x₀ [symbol] T, x₁ [symbol] T] is shown in bold.

FIG. 2 illustrates matched paths in a CFLOBDD.

FIG. 3 shows an OBDD and a CFLOBDD for the two-input function λx₀. x₁.x₀ [symbol] x₁. In each of

FIGS. 3(c) and 3(f), the path corresponding to the assignment [x₀ [symbol] T, x₁ [symbol] T] is shown in bold.

FIG. 4 shows fully expanded and folded CFLOBDDs for the four-input Boolean function λx₀x₁x₂x₃.(x₀ [symbol] x₁)V(x₂ [symbol] x₃).

FIG. 5 shows a multi-terminal CFLOBDD that represents a function that maps Boolean arguments to the set {a, b, c}.

FIG. 6 illustrates how a CFLOBDD relates to the corresponding decision tree for a more complicated example. FIG. 6(c) also shows a CFLOBDD that contains an occurrence of a proto-CFLOBDD that has more than two exit vertices.

FIG. 7 shows the unique single-entry/single-exit (or “no-distinction”) proto-CFLOBDDs of levels 0, 1, and 2, and also illustrates the structure of a no-distinction proto-CFLOBDD for arbitrary level k.

FIG. 8 illustrates an invariant on the representation that must be maintained for CFLOBDDs to provide a canonical representation of functions over Boolean-valued arguments.

FIG. 9 illustrates the four cases that arise in the proof of Proposition 1.

FIGS. 10 and 11 illustrate the steps taken when folding a decision tree into a CFLOBDD, and when unfolding a CFLOBDD to create the corresponding decision tree.

FIG. 12 defines the classes used for representing CFLOBDDs in a computer's memory.

FIG. 13 explains the SETL-based notation [Dew79, SDDS87] used for expressing the CFLOBDD algorithms

FIG. 14 shows how the CFLOBDD from FIG. 4(b) would be represented as an instance of the class CFLOBDD defined in FIG. 12.

FIG. 15 presents pseudo-code for constructing no-distinction proto-CFLOBDDs.

FIG. 16 illustrates the structure of the CFLOBDDs that represent projection functions of the form λx₀, x₁, . . . , x₂_{^{k}}₋₁.xᵢ, where i ranges from 0 to 2^{k}-1. Pseudo-code for the construction of these object given in FIG. 17.

FIG. 18 illustrates the structure of decision trees that represent step functions of the form

$$λ {x}_{0} , {x}_{1} , … , {{x}_{{2}^{k}}}_{- 1} \cdot \{ \begin{matrix} {v}_{1} if the number whose bits are {x}_{0} {x}_{1} {{…x}_{{2}^{k}}}_{- 1} is strictly less than i \\ {v}_{2} if the number whose bits are {x}_{0} {x}_{1} {{…x}_{{2}^{k}}}_{- 1} is greater than or equal to i \end{matrix}$$

where i ranges from 0 to 2²^{^{k}}. FIG. 19 presents pseudo-code for constructing CFLOBDDs that represent step functions.

FIG. 20 presents an algorithm that applies in the special situation in which a CFLOBDD maps Boolean-variable-to-Boolean-value assignments to just two possible values; the algorithm flips the two values. In the case of Boolean-valued CFLOBDDs, this operation can be used to implement the Not operation in an efficient manner.

FIG. 21 presents an algorithm that applies to any CFLOBDD that maps Boolean-variable-to-Boolean-value assignments to values on which multiplication by a scalar value is defined.

FIGS. 22, 23, 24, 25, 26, and 27 present the core algorithms for manipulating CFLOBDDs.

FIG. 28 shows how to use the ternary ITE operation to implement all 16 of the binary Boolean-valued operations.

FIG. 29 illustrates how the Kronecker product of two matrices can be represented using CFLOBDDs.

FIGS. 30, 32, and 34 illustrate the structure of the CFLOBDDs that encode the families of integer matrices for the Reed-Muller transform, the inverse Reed-Muller transform, and the Walsh transform, respectively. Pseudo-code for the construction of these objects is given in FIGS. 31, 33, and 35, respectively.

FIGS. 36, 37, 38, 39, 40, and 41 illustrate the construction that is used to create the CFLOBDDs that encode the families of integer matrices for the Boolean Haar Wavelet transform.

FIG. 42 presents pseudo-code for an efficient way to uncompress a multi-terminal CFLOBDD to recover the sequence of values that would label, in left-to-right order, the leaves of the corresponding decision tree.

### DETAILED DESCRIPTION OF THE INVENTION

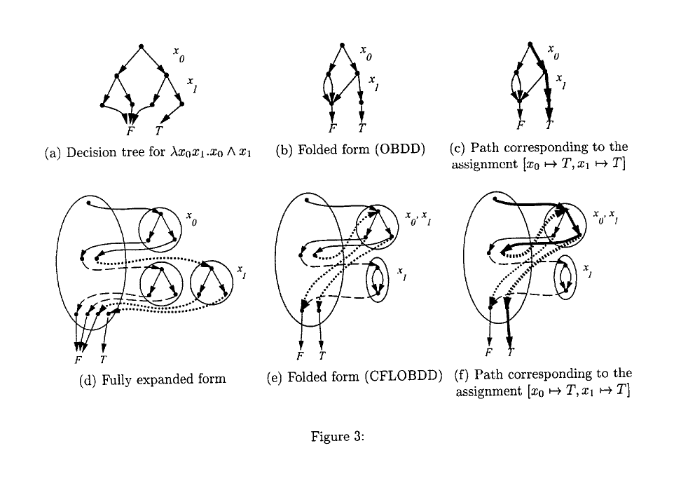

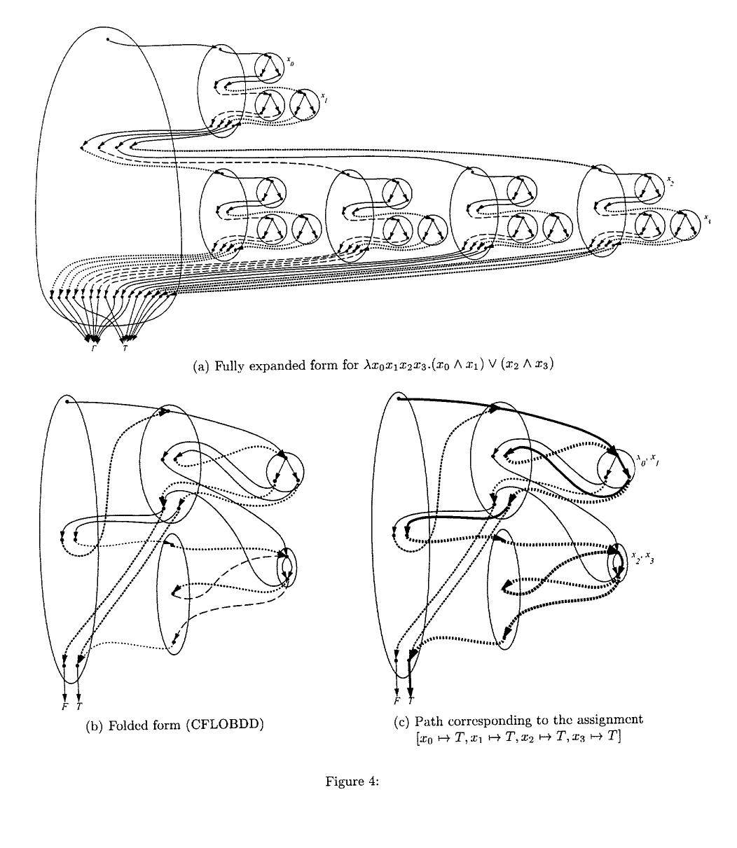

CFLOBDDs can be considered to be a variant of BDDs in which further folding is performed on the graph. The folding principle is somewhat subtle, because BDDs are DAGs, and folding a DAG leads to cyclic graphs—and hence an infinite number of paths. (This phenomenon does not occur in FIG. 1, but we will start to see CFLOBDDs that contain cycles when we discuss FIGS. 3 and 4.)

The circles and ovals show groupings of vertices into levels: In FIGS. 1(d)-(f), 2(a)-(h), and 3(d)-(f), the small circles/ovals represent the level-0 groupings, and the large oval in each figure represents the level-1 grouping. (In FIG. 4, there are several level-1 groupings in each diagram, and the largest oval in each diagram represents a level-2 grouping.)

At this point, it is convenient to introduce some terminology to refer to the individual components of CFLOBDDs and groupings within CFLOBDDs (see FIG. 1(e)):

The vertex positioned at the top of each grouping is called the grouping's entry vertex.

The collection of vertices positioned at the middle of each grouping at level 1 or higher is called the grouping's middle vertices. We assume that a grouping's middle vertices are arranged in some fixed known order (e.g., they can be stored in an array).

The collection of vertices positioned at the bottom of each grouping is called the grouping's exit vertices. We assume that a grouping's exit vertices are arranged in some fixed known order (e.g., they can be stored in an array).

The edge that emanates from the entry vertex of a level-i grouping g and leads to a level i-1 grouping is called g's A-connection.

An edge that emanates from a middle vertex of a level-i grouping g and leads to a level i-1 grouping is called a B-connection of g.

The edges that emanate from the exit vertices of a level i-1 grouping and lead back to a level i grouping are called return edges.

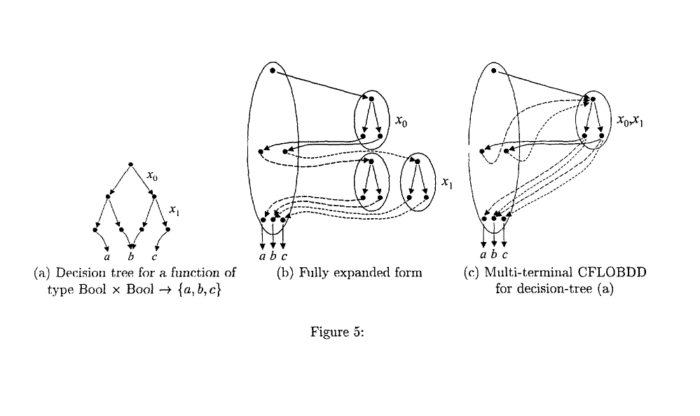

The edges that emanate from the exit vertices of the highest-level grouping and lead to a value are called value edges. In the case of a Boolean-valued CFLOBDD, the highest-level grouping has at most two exit vertices, and these are mapped uniquely to {F,T} (cf. FIGS. 1(e), 3(e), and 4(b)). In the case of a multi-terminal CFLOBDD, there can be an arbitrary number of exit vertices, which are mapped uniquely to values drawn from some finite set (cf FIG. 5(c), where the values are drawn from the set {a, b, c}).

In all cases, it is the entry vertex of a level-0 grouping that corresponds to a decision point in the corresponding decision tree. There are only two possible types of level-0 groupings:

A level-0 grouping like the one reached via the A-connection in FIG. 1(e) is called a fork grouping.

A level-0 grouping like the one reached via the B-connections in FIG. 1(e) is called a don't-care grouping.

FIG. 1(e) shows the CFLOBDD for the function λx₀x₁₀. A CFLOBDD can be used to evaluate a Boolean function by following a path from the entry vertex of the highest-level grouping (i.e., in FIG. 1(e), the entry vertex of the level-1 grouping), making “decisions” for the next variable in sequence each time the entry vertex of a level-0 grouping is encountered. For instance, the bold path shown in FIG. 1(f) corresponds to the assignment [x₀ [symbol] T, x₁ [symbol] T]. FIG. 1(d) shows the fully expanded form of the CFLOBDD from FIG. 1(e). For the CFLOBDD of FIG. 1(e), FIG. 1(d) is the analog of the binary decision tree shown in FIG. 1(a) for the OBDD of FIG. 1(b). (As with BDDs and their decision trees, the fully expanded form of a CFLOBDD need never be materialized. It is shown here for illustrative purposes only.)

The don't-care grouping in the lower right-hand corner of FIG. 1(f) illustrates the key principle behind CFLOBDDs-namely, how a matched-path condition on paths allows a given region of a graph to play multiple roles during the evaluation of a Boolean function. The path corresponding to the assignment [x₀ [symbol] T, x₁ [symbol] T]enters the level-0 grouping for x₁ (a don't-care grouping) via the B-connection depicted as a dotted edge; the path leaves the level-0 grouping for x₁ via the dotted return edge (as opposed to the dashed return edge). We say that a pair of incoming and outgoing edges such as the two dotted edges in this path are matched, and that the path in FIG. 1(f) is a matched path.

This example illustrates the following principle:

Matched Path Principle. When a path follows a return edge from level i -1 to level i, it must follow a return edge that matches the closest preceding connection edge from level i to level i-1.⁴ ⁴ Dotted and dashed edges are used in the figures shown here rather than attaching explicit labels to them. Formally, the matched-path principle can be expressed as a condition that—for a path to be matched—the word spelled out by the labels on the edges of the path must be a word in a certain context-free language, as described below. (This is the origin of “CFL” in “CFLOBDD”.)

One way to formalize the condition is to label each connection edge from level i to level i-1 with an open-parenthesis symbol of the form “(b”, where b is all index that distinguishes the edge from all other edges to any entry vertex of any grouping of the CFLOBDD. (In particular, suppose that there are Num Connections such edges, and that the value of b runs from 1 to Num connections.) Each return edge that runs from an exit vertex of the level i-1 grouping back to level i, and corresponds to the connection edge labeled “(b”, is labeled “)b”. Each path in a CFLOBDD then generates a string of parenthesis symbols formed by concatenating, in order, the labels of the edges on the path. (Unlabeled edges in the level-0 groupings are ignored in forming this string.) A path in a CFLOBDD is called a Matched-path if the path's word is in the language L(Matched) of balanced-parenthesis strings generated from nonterminal Matched according to the following context-free grammar:

$$\begin{matrix}Matched \to Matched Matched \\ \vert {{(}_{b} Matched )}_{b} 1 \leq b \leq NumConnections \\ \vert ε\end{matrix}$$

Only Matched-paths that start at the entry vertex of the CFLOBDD's highest-level grouping and end at one of the final values are considered in interpreting CFLOBDDS. assignment of values for the variables x₀ and x₁.

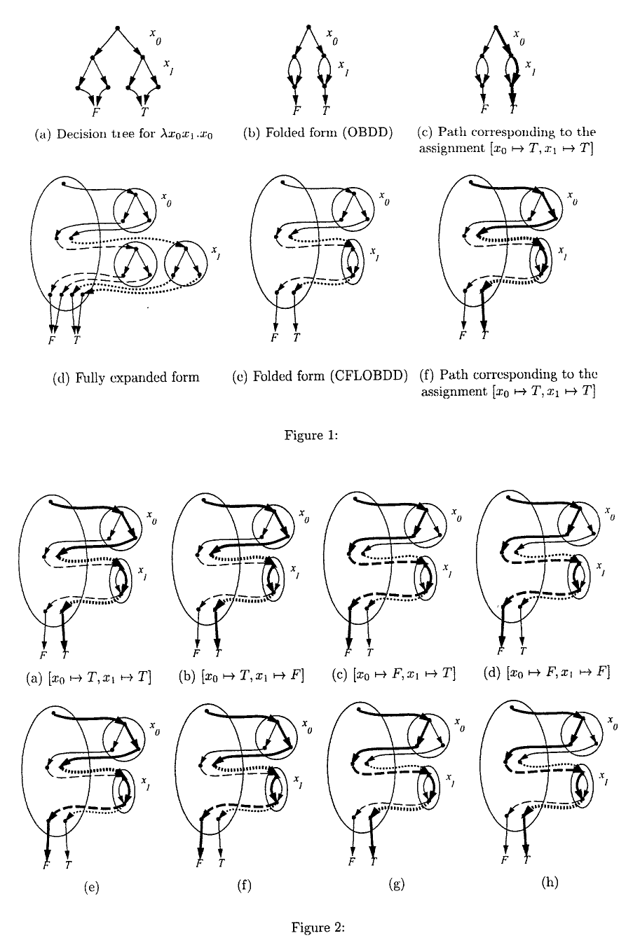

The matched-path principle allows a single region of a CFLOBDD to do double duty (and, in general, to perform multiple roles). For example, in FIG. 1(e), the level-0 don't-care grouping in the lower right-hand corner is used for discriminating on x₁, both in the case that x₀ has the value F and in the case that x₀ has the value T (see FIGS. 2(a)-2(d)). In FIG. 2(a), we can see that for the function λx₀x₁.x₀ to be interpreted correctly under the assignment [x₀ [symbol] T, x₁ [symbol] T]), the distinction between the dotted return edge and the dashed return edge is crucial: The dotted return edge that occurs in the path in FIG. 2(a) takes us to T (the correct answer for the evaluation of λx₀x₁.x₀ under [x₀ [symbol] T, x₁ [symbol] T]), whereas the dashed return edge would take us to F, which would be incorrect (cf. the unmatched path shown in FIG. 2(e)). The dashed return edge is used only when the lower level-0 grouping is entered via the incoming dashed edge (as happens in FIGS. 2(c) and 2(d) for the assignments [x₀ [symbol] F, x₁ [symbol] T] and [x₀ [symbol] F, x ₁ [symbol] F], respectively).

The matched-path principle also lets us handle the cycles that can occur in CFLOBDDs. FIG. 3 shows the OBDD and CFLOBDD for the two-input function λx₀x₁.x₀ [symbol] x₁. In this case, the “forking” pattern at level 0, which appears in the upper right-hand corner of FIG. 3(e), is used for discriminating on variable x₀, and also, in the case when x₀ is mapped to T, for discriminating on x₁. The double use of this subgraph is illustrated in FIG. 3(f), which shows in bold the path corresponding to the assignment [x₀ [symbol] T, x₁ [symbol] T]. Again, the matched-path principle allows us to obtain the desired interpretation of the CFLOBDD: In the case of the assignment [x₀ [symbol] T, x₁ [symbol] T], the first time the path reaches the level-0 fork grouping (labeled “x₀, x₁”), it enters via the A-connection edge, which is solid, and therefore the path must leave via a solid return edge. In this case, because x₀ has the value T in the assignment, the path reaches a middle vertex whose B-connection edge leads back to the level-0 fork grouping, but this time via the dotted edge. (Note that at this point the path has gone once around the cycle that exists in the CFLOBDD.) Because the path enters the level-0 fork grouping via the dotted B-connection edge, it must leave via a dotted return edge—in this case, the one that takes us to T.

Not only does the matched-path principle allow us to obtain the desired interpretation of a CFLOBDD, but it allows such interpretations to be obtained correctly in the presence of cycles: In the absence of the matched-path principle, a path could cycle endlessly between the level-1 grouping and the level-0 fork grouping.

FIG. 4 depicts fully expanded and folded CFLOBDDs for the four-input function λx₀x₁x₂x₃.(x₀ [symbol] x₁)V (x₂ [symbol] x₃). In the case of the folded CFLOBDD shown in FIG. 4(b), there are exactly seven matched paths from the entry vertex to T. These correspond to the seven paths from entry to T in the fully expanded form. In FIG. 4(c), the path corresponding to the assignment [x₀ [symbol] T, x₁ [symbol] T, x₂ [symbol] T, x₃ [symbol] t] is shown in bold. In this path, the upper level-0 grouping is used to handle x₀ and x₁, while the lower level-0 grouping handles x₂ and x₃. The correspondence between groupings and variables varies from path to path. For instance, the upper level-0 grouping would handle all four variables for the variable assignment [x₀ [symbol] T, x₁ [symbol] F, x₂ [symbol] T, x₃ [symbol] F].

Comparing FIG. 4(a) with FIG. 4(b), one can see that a great deal of compression has taken place. In fact, for the family of functions of the form λx₀x₁. . . xₖ. (x₀ [symbol] x₁)V . . . V(xₖ₋₁ [symbol] x ₖ) with the variable ordering x₀, x₁, . . . , xₖ, the sizes of their CFLOBDDs are bounded by O (log₂ k). In contrast, the sizes of the OBDDs for this family of functions grows as O (k). (Obviously, the decision trees for this family of functions grow as O(2^{k}).)

FIG. 1(f) is repeated in FIG. 2 as FIG. 2(a). FIGS. 2(a)-2(d) show all four matched paths that exist in the CFLOBDD for the function λx₀ₓ₁x₀. The paths shown in FIGS. 2(e)-2(h) are the four paths in the CFLOBDD that violate the matched-path condition; these paths do not correspond to any possible

In general, as the level of the highest-level grouping increases, a CFLOBDD's characteristics grow as follows:

| CFLOBDD | Boolean | Number | Length of |
|---|---|---|---|
| level | vars. | of paths | each path |
| 0 | 1 | 2 | 1 |
| 1 | 2 | 4 | 6 |
| 2 | 4 | 16 | 16 |
| 3 | 8 | 256 | 36 |
| . | . | . | . |
| . | . | . | . |
| . | . | . | . |
| L | 2^{L} | 2²^{^{L}} | 5 × 2^{L} − 4 |

Note that the number of paths in a CFLOBDD is squared with each increase in level by 1: In a grouping at level i, each path through the A-connection's level i-1 grouping is routed through some B-connection's level i-1 grouping. Each level i-1 grouping has 2²^{ⁱ⁻¹} paths, and therefore, by induction, each level i grouping has 2²^{ⁱ} paths. (The base case is that each of the two possible level-0 groupings has 2 =2²^{⁰} paths.)

Each CFLOBDD of level L represents a decision tree with 2²^{^{L}} leaves and height 2_{L}. In terms of representing a family of functions, fᵢ, where the i^{th} member has 2ⁱ Boolean-valued arguments, the best case occurs when each grouping in each CFLOBDD that represents one of the f₂ is of constant size (i.e., O(1)), and thus the level-L CFLOBDD in the family is of size O(L). In this case, a doubly-exponential compression of the decision trees for the family of functions {fᵢ} is achieved.

It should be noted that no information-theoretic limit is being violated here: Not all decision trees can be represented with CFLOBDDs in which each grouping is of constant size—and thus, not every function over Boolean-valued arguments can be represented in such a compressed fashion (i.e., logarithmic in the number of Boolean variables, or, equivalently, doubly logarithmic in the size of the decision tree). However, the potential benefit of CFLOBDDs is that, just as with BDDs, there may turn out to be enough regularity in problems that arise in practice that CFLOBDDs stay of manageable size. Moreover, doubly-exponential compression (or any kind of super-exponential compression) could allow problems to be completed much faster (due to the smaller-sized structures involved), or allow far larger problems to be addressed than has been possible heretofore.

For example, if you want to tackle a problem with 2¹⁶=65,536 variables (and thus a state space of size 2²^{¹⁶} =2^{65,536}≈10^{22,000}), it might be possible to get by with CFLOBDDs consisting of some small multiple of log₂log₂2²^{¹⁶}=16 vertices (grouped into 16 levels). If the problem involves 2²⁰=1, 048,5762 variables (and thus a state space of size 2²^{²⁰}=2^{1,048,576}≈10^{350,000}), then you might have to use slightly larger CFLOBDDs—i.e., ones with some small multiple of log₂log₂ 2²^{²⁰}=20 vertices. In contrast, one would need BDDs with (small multiples of) 65,536 vertices and 1,048,576 vertices, respectively. Not only would CFLOBDDs potentially save a great deal of space, but operations on CFLOBDDs could potentially be performed much faster than operations on the corresponding BDDs.

In the discussion of CFLOBDDs and multi-terminal CFLOBDDs that follows, it is convenient to introduce the term proto-CFLOBDDs to refer to an additional feature of CFLOBDD structures. Proto-CFLOBDDs have already been illustrated in previous examples (albeit not in full generality): Each grouping, together with the lower-level subgroupings that it is connected to, forms a proto-CFLOBDD. Thus, the difference between a proto-CFLOBDD and a CFLOBDD is that the exit vertices of a proto-CFLOBDD have not been associated with specific values.

A level-i Booleani-valued CFLOBDD consists of a level-i proto-CFLOBDD that has at most two exit vertices, which are then associated uniquely with F and T (cf. FIGS. 1(e), 3(e), and 4(b)).

A level-i multi-terminal CFLOBDD consists of a level-i proto-CFLOBDD that may have an arbitrary number of exit vertices, which are then associated uniquely with values drawn from some value space. For instance, FIG. 5(c) shows the multi-terminal CFLOBDD that represents the decision tree shown in FIG. 5(a), which maps Boolean arguments x₀ and x₁ to the set {a, b, c}.

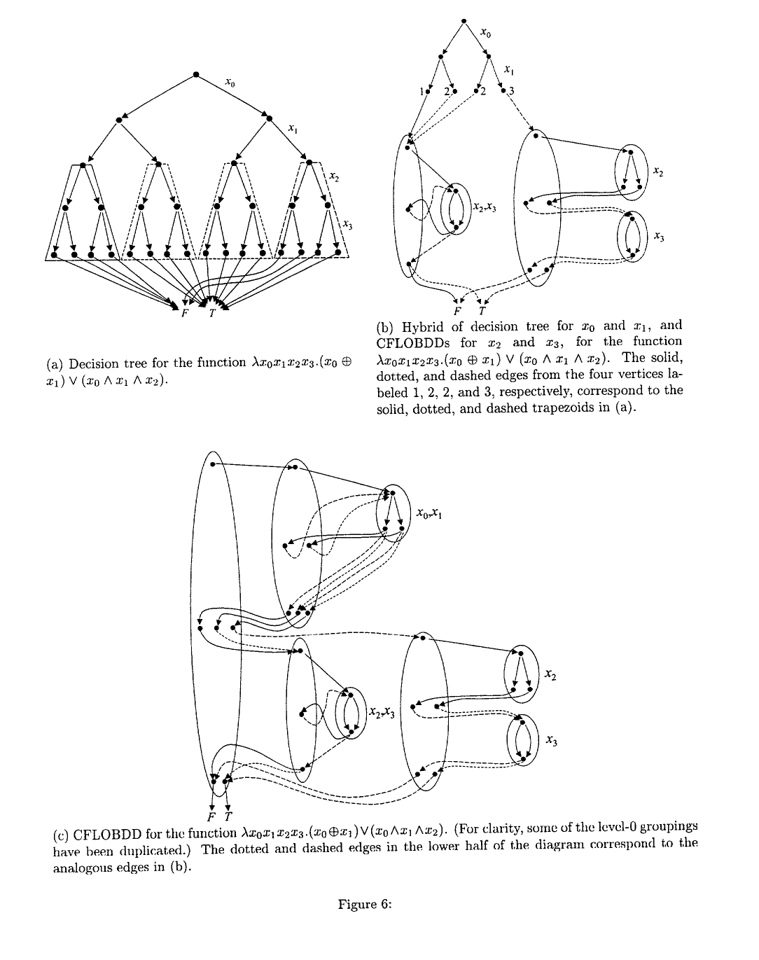

Groupings, and proto-CFLOBDDs, that have more than two exit vertices naturally arise in the sub-groupings CFLOBDDs—even in Boolean-valued CFLOBDDs. For instance, the highest-level grouping in a Boolean-valued CFLOBDD (at, say, level k) may contain more than two riddle vertices, and thus the level k-1 grouping for the A-connection will have more than two exit vertices. At lower levels, multi-terminal groupings can arise in both A-connections and B-connections. FIG. 6(c) shows a Boolean-valued CFL-OBDD that contains an occurrence of a proto-CFLOBDD that has more than two exit vertices. In particular, the level-1 proto-CFLOBDD pointed to by the A-connection of the level-2 grouping in FIG. 6(c) has three exit vertices.

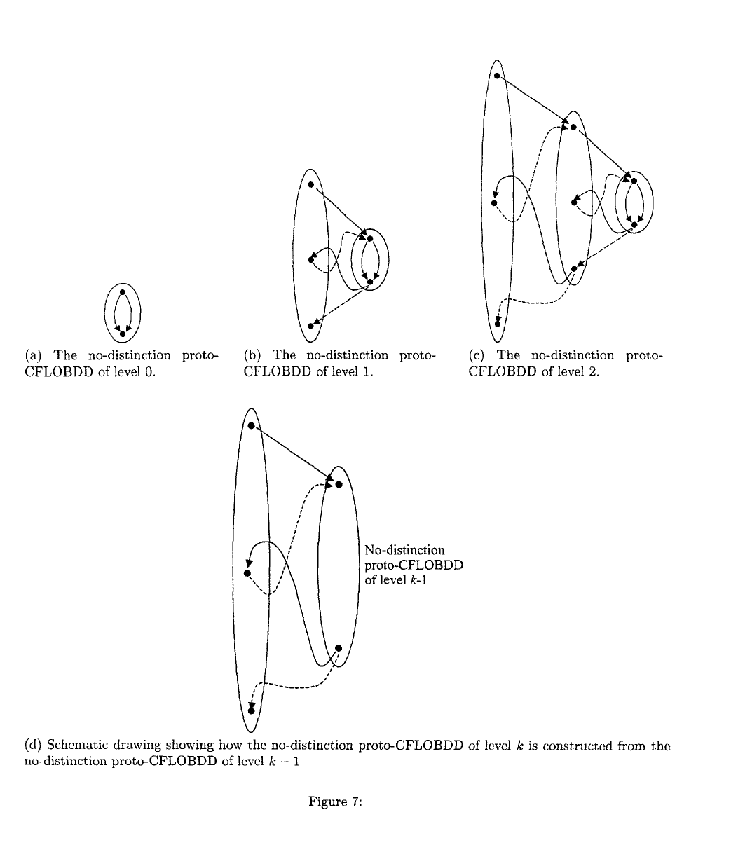

FIGS. 7(a), 7(b), and 7(c) show the first three members of a family of proto-CFLOBDDs that often arise as sub-structures of CFLOBDDs; these are the single-entry/single-exit proto-CFLOBDDs of levels 0, 1, and 2, respectively. Because every matched path through each of these structures ends up at the unique exit vertex of the highest-level grouping, there is no “decision” to be made during each visit to a level-0 grouping. In essence, as we work our way through such a structure during the interpretation of an assignment, the value assigned to each argument variable makes no difference.

We call this family of proto-CFLOBDDs the no-distinction proto-CFLOBDDs. FIGS. 7(a), 7(b), is and 7(c) show the no-distinction proto-CFLOBDDs of levels 0, 1, and 2; FIG. 7(d) illustrates the structure of a no-distinction proto-CFLOBDD for arbitrary level k. The no-distinction proto-CFLOBDD for level k is created by continuing the same pattern that one sees in the level-1 and level-2 structures: the level-k grouping has a single middle vertex, and both its A-connection and its one B-connection are to the no-distinction proto-CFLOBDD of level k-1.

Boolcan-valued CFLOBDDs for the constant functions of the form λx₀, x₁, . . . , x₂_{^{k}}₋₁.F are merely the CFLOBDDs in which the (one) exit vertex of the no-distinction proto-CFLOBDD of level k is connected to F. Likewise, the constant functions of the form λx₀, x₁, . . . , x₂_{^{k}}₋₁. are the CFLOBDDs in which the exit vertex of the no-distinction proto-CFLOBDD of level-k is connected to T.

Note that the no-distinction proto-CFLOBDD of level k is of size O(k), and hence the no-distinction proto-CFLOBDDs exhibit doubly exponential compression. Moreover, because the no-distinction proto-CFLOBDD of level k shares all but one constant-sized grouping with the no-distinction proto-CFLOBDD of level k-1, each additional no-distinction proto-CFLOBDD costs only a constant amount of additional space.

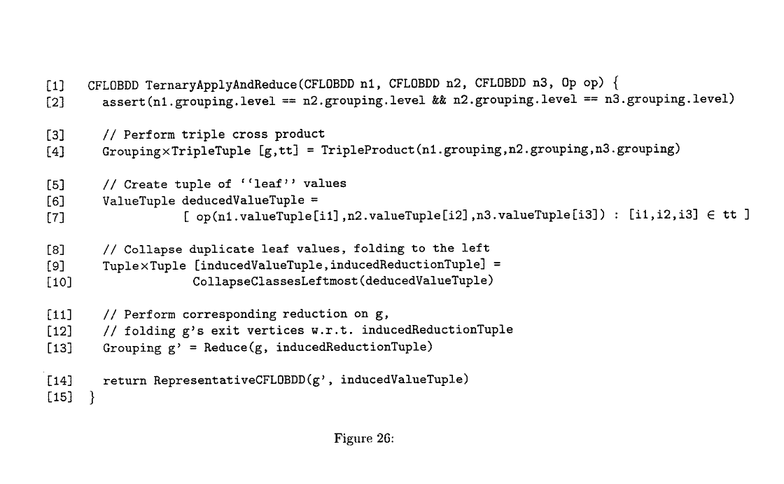

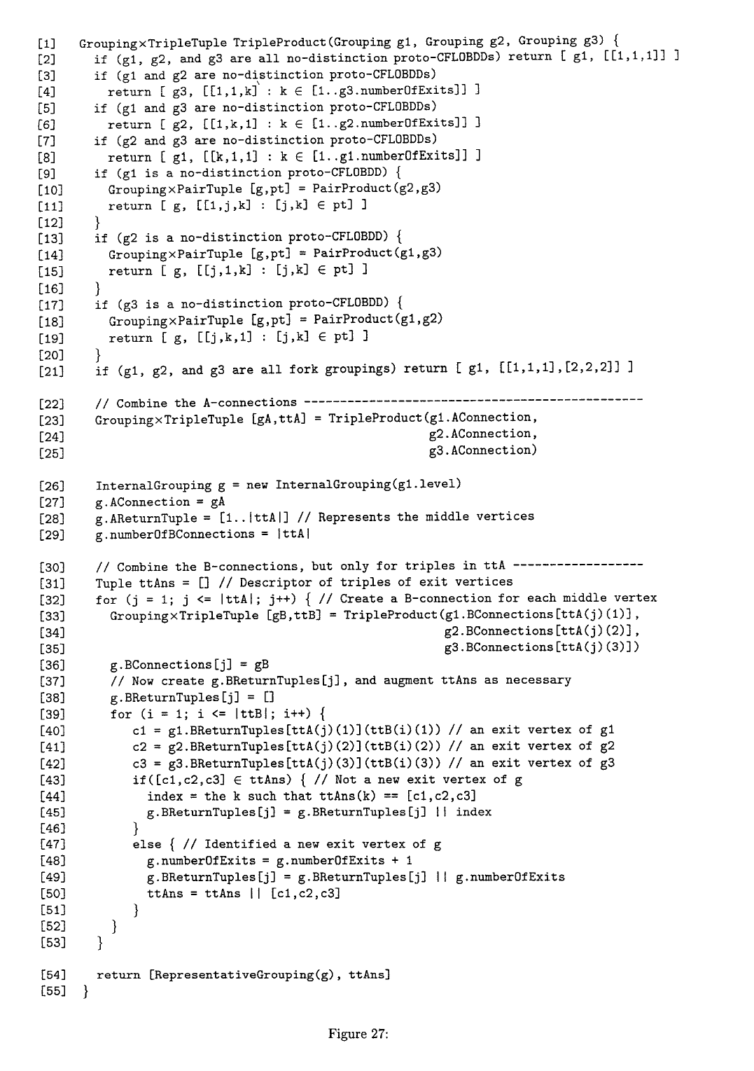

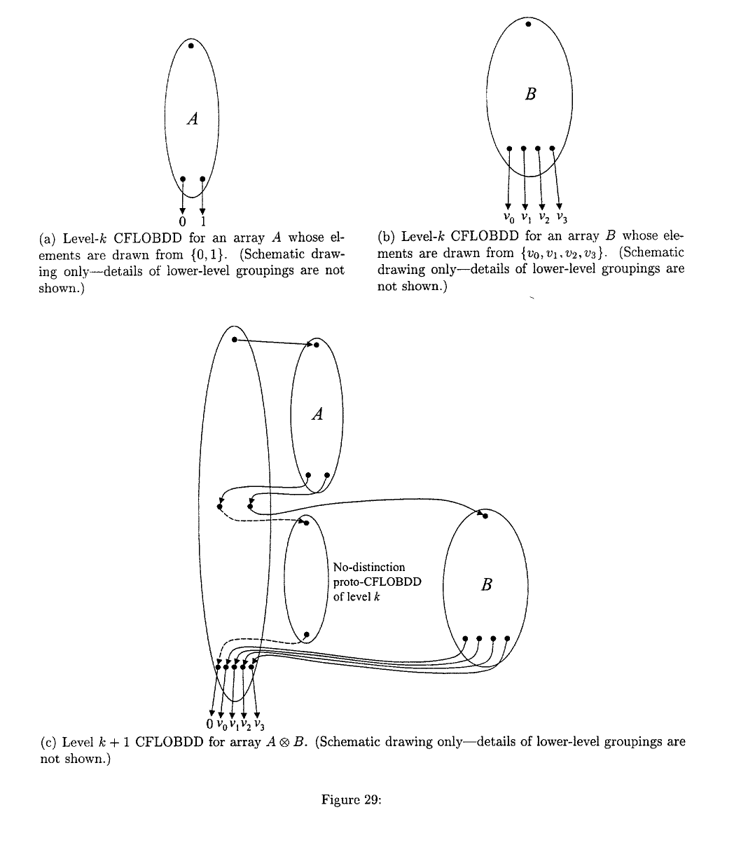

It is because the family of no-distinction proto-CFLOBDDs is so compact that in designing CFL-OBDDs we did not feel the need to mimic the “reduction transformation” of Reduced OBDDs (ROB-DDs) [Bry86, BRB90], in which “don't-care” vertices are removed from the representation.⁵ In ROBDDs, in addition to reducing the size of the data structure, the chief benefit of the reduction transformation is that operations can skip over levels in portions of the data structure in which no distinctions among variables are made. Essentially the same benefit is obtained by having the algorithms that process CFLOBDDs carry out appropriate special-case processing when no-distinction proto-CFLOBDDs arc encountered. (This is carried out in lines [2]—[6] of FIG. 24, lines [16]-[17] of FIG. 25, and lines [2]-[20]of FIG. 27.) ⁵The “reduction transformation” is not to be confused with the Reduce operation that is part of the algorithm for carrying out operations on OBDDs and MTBDDs [Bry86, CMZ⁺93, CFZ95a]. The algorithm for carrying out operations on CFLOBDDs does have an analog of the Reduce operation (see FIG. 25).

ADDITIONAL STRUCTURAL INVARIANTS

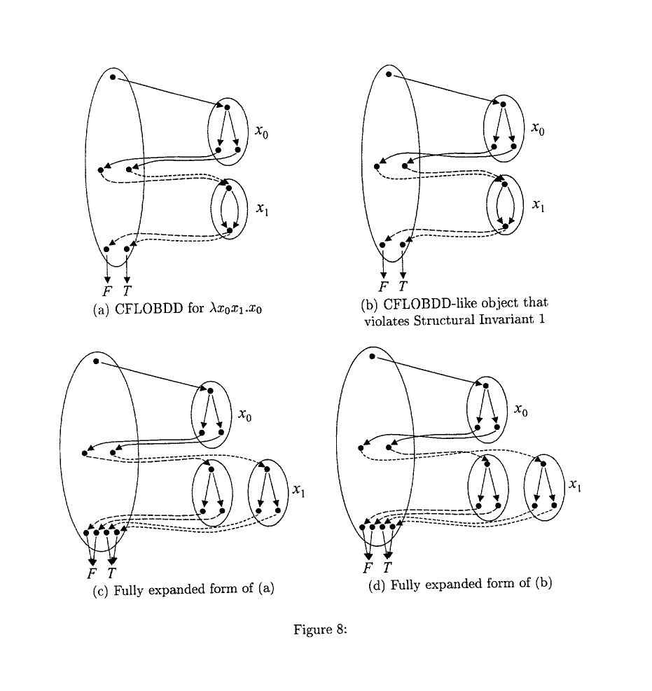

The structures that have been described thus far are too general; in particular, they do not yield a canonical form for functions over Boolean-valued arguments. This is illustrated in FIGS. 8(a) and 8(b), which show two CFLOBDD-like objects that, when assignments to x₀ and x₁ are interpreted along matched paths, both correspond to the function λx₀x₁.x₀. The difference between FIGS. 8(a) and 8(b) is that the ordering of the middle vertices of their level-1 groupings are different.

Thus, in addition to the basic hierarchical structure that is provided by A-connections, B-connections, and return edges, we impose certain additional structural invariants on CFLOBDDs. As shown below, when these invariants are maintained, the CFLOBDDs are a canonical form for functions over Boolean arguments.

Most of the structural invariants concern the organization of what we shall call return tuples: For a given A-connection or B-connection edge c from grouping gᵢ to gᵢ₋₁ the return tuple rt_{C} associated with c consists of the sequence of targets of return edges from gᵢ₋₁ to gᵢ that correspond to c (listed in the order in which the corresponding exit vertices occur in gᵢ₋₁. Similarly, the sequence of targets of value edges that emanate from the exit vertices of the highest-level grouping g (listed in the order in which the corresponding exit vertices occur in g) is called the CFLOBDD's value tuple.

We can think of return tuples as representing mapping functions that map exit vertices at one level to middle vertices or exit vertices at the next greater level. Similarly, value tuples represent mapping functions that map exit vertices of the highest-level grouping to final values. In both cases, the i^{th} entry of the tuple indicates the element that the i^{th} exit vertex is mapped to.

Because the middle vertices and exit vertices of a grouping are each arranged in some fixed known order, and hence can be stored in an array, it is often convenient to assume that each element of a return tuple is simply an index into such an array. For example, in FIG. 5(c),

The return tuple associated with the first B-connection of the level-1 grouping is the 2-tuple [1, 2].

The return tuple associated with the second B-connection of the level-1 grouping is 2-tuple [2,3].

The value tuple associated with the multi-terminal CFLOBDD is the 3-tuple [a, b, c].

We impose five conditions:

STRUCTURAL INVARIANTS

1. If c is an A-connection, then rt_{c} must map the exit vertices of gᵢ₋₁ one-to-one, and in order, onto the middle vertices of gᵢ: Given that gᵢ₋₁ has k exit vertices, there must also be k middle vertices in gᵢ, and rt_{c} must be the k-tuple [1, 2, . . . , k]. (That is, when rt_{c} is considered as a map on indices of exit vertices of gᵢ₋₁, rt_{c} is the identity map.)

2. If c is the B-connection edge whose source is middle vertex j+1 of gᵢ and whose target is gᵢ₋₁, then rt_{c} mast meet two conditions:

(a) It must map the exit vertices of gᵢ₋₁ one-to-one (but not necessarily onto) the exit vertices of gᵢ. (That is, there are no repetitions in rt_{c}.)

(b) It must “compactly extend” the set of exit vertices in gᵢ defined by the return tuples for the previous j B-connections: Let rt_{c}_{₁}, rt_{c}_{₂}, . . . , rt_{c}_{₁} be the return tuples for the first j B-connection edges out of gᵢ. Let S be the set of indices of exit vertices of gᵢ that occur in return tuples rt_{c}_{₁}, rt_{c}_{₂}, . . . , rt_{c}_{₁} and let n be the largest value in S. (That is, n is the index of the rightmost exit vertex of gᵢ that is a target of any of the return tuples rt_{c}_{₁}, rt_{c}_{₂}, . . . , rt_{c}_{₁}) If S is empty, then let a be 0.

Now consider rt_{c} (=rt_{c}_{₃₊₁}). Let R be the (not necessarily contiguous) sub-sequence of rt_{c} whose values are strictly greater than n. Let m be the size of R. Then R must be exactly the sequence [n+1, n+2, . . . , n+m].

3. While a proto-CFLOBDD may be used as a substructure more than once (i.e., a proto-CFLOBDD may be pointed to multiple times), a proto-CFLOBDD never contains two separate instances of equal proto-CFLOBDDs.⁶ ⁶Equality on proto-CFLOBDDs is defined inductively on their hierarchical structure in the obvious manner. However, it is important to note, that, in an attempt to reduce clutter, our diagrams often show, multiple instances of the two kinds of level-0 groupings; in fact, at CFLOBDD can contain at most one copy of each.

4. For every pair of B-connections c and c¹ of grouping g₂, with associated return tuples rt_{c} , and rt_{c}_{¹}, if c and c¹ lead to level i-1 proto-CFLOBDDs, say p₂₋₁ and p¹₂₋₁ such that p₂₋₁=p¹₂₋₁, then the associated return tuples must be different (i.e., rt_{c}#rt_{c}_{¹}).

5. For the highest-level grouping of a CFLOBDD, the value tuple maps each exit vertex to a distinct value.

Structural Invariants 1, 2, and 4 are illustrated in FIGS. 8 and 6

FIG. 8(b) violates condition 1, and hence does not qualify as being a CFLOBDD.

In FIG. 6(c), the level-1 grouping pointed to by the A-connection of the level-2 grouping has three exit vertices. These are the targets of two return tuples from the uppermost level-0 fork grouping. Note that dashed lines in this proto-CFLOBDD correspond to B-connection 1 and rt₁, whereas dotted lines correspond to B-connection 2 and rt₂.

In the case of rt₁, the set S mentioned in Structural Invariant 2b is empty; therefore, n=0 and rt₁ is constrained by Structural Invariant 2b to be [1, 2].

In the case of rt₂, the set S is {1, 2}, and therefore n=2. The first entry of rt₂, namely 2, falls within the range [1..2]; the second entry of rt₂ lies outside that range and is thus constrained to be 3. Consequently, rt₂=[2,3].

Also in FIG. 6(c), because the level-1 grouping pointed to by the A-connection of the level-2 grouping has three exit vertices, these are constrained by Structural Invariant 1 to map in order over to the three middle vertices of the level-2 grouping; i.e., the corresponding return tuple is [1, 2, 3].

In FIG. 6(c), the B-connections for the first and second middle vertices of the level-2 grouping are to the same level-1 grouping; however, the two return tuples are different, and thus are consistent with Structural Invariant 4.

The following proposition demonstrates that matched paths through proto-CFLOBDDs (and hence through CFLOBDDs) reflect a certain ordering property on Boolean-variable-to-Boolean-value assignments.

Proposition 1 Let ex_{C} be the sequence of exit vertices of proto-CFLOBDD C. Let ex_{L} be the sequence of exit vertices reached by traversing C on each possible Hoolean-variable-to-Boolean-value assignment, generated in lexicographic order of assignments. Let s be the subsequence of ex_{L} that retains just the leftmost occurrences of members of ex_{L} (arranged in order as they first appear in ex_{L}). Then ex_{C}=s.

Proof: We argue by induction

Base case: The proposition follows immediately for level-0 proto-CFLOBDDs.

Induction step: The induction hypothesis is that the proposition holds for every level-k proto-CFLOBDD.

Let C be an arbitrary level k+1 proto-CFLOBDD, with s and ex_{C} as defined above. Without loss of generality, we will refer to the exit vertices by ordinal position; i.e., we will consider ex_{C} to be the sequence [1,2, . . . , |ex_{C}|]. Let C_{A} denote the A-connection of C, and let C_{B}_{ₙ} denote C's n^{th} B-connection. Note that C_{A} and each of the C_{B}_{ₙ}, are level-k proto-CFLOBDDs, and hence, by the induction hypothesis, the proposition holds for them.

We argue by contradiction: Suppose, for the sake of argument, that the proposition does not hold for C, and that j is the leftmost exit vertex in ex_{C} for which the proposition is violated (i.e., s(j)#j). Let i be the exit vertex that appears in the j^{th} position of s (i.e., s(j)=i). It must be that j<i.

Let αⱼ and αᵢ be the earliest assignments in lexicographic order (denoted by <) that lead to exit vertices j and i, respectively. Because i comes before j in s, it must be that αᵢ<αⱼ.

Let αⱼ¹ and αⱼ² denote the first and second halves of αⱼ respectively; let αᵢ¹ and αᵢ² denote the first and second halves of αᵢ respectively. Let + denote the concentration of assignments (e.g., αⱼ=αⱼ¹+αⱼ²).

There are two cases to consider.

Case 1: α=aⱼ¹and a α₁²<αⱼ².

Because α=αⱼ, the first halves of the matched path followed during the interpretations of assignments αᵢ and αⱼ through C_{A} are identical, and bring us to some middle vertex, say m, of C; both paths then proceed through C_{B}_{ₘ}. Let eᵢ, and eⱼ, be the two exit vertices of C_{B}_{ₘ} reached by following matched paths during the interpretations of aαᵢ² and αⱼ² respectively. There are now two cases to consider:

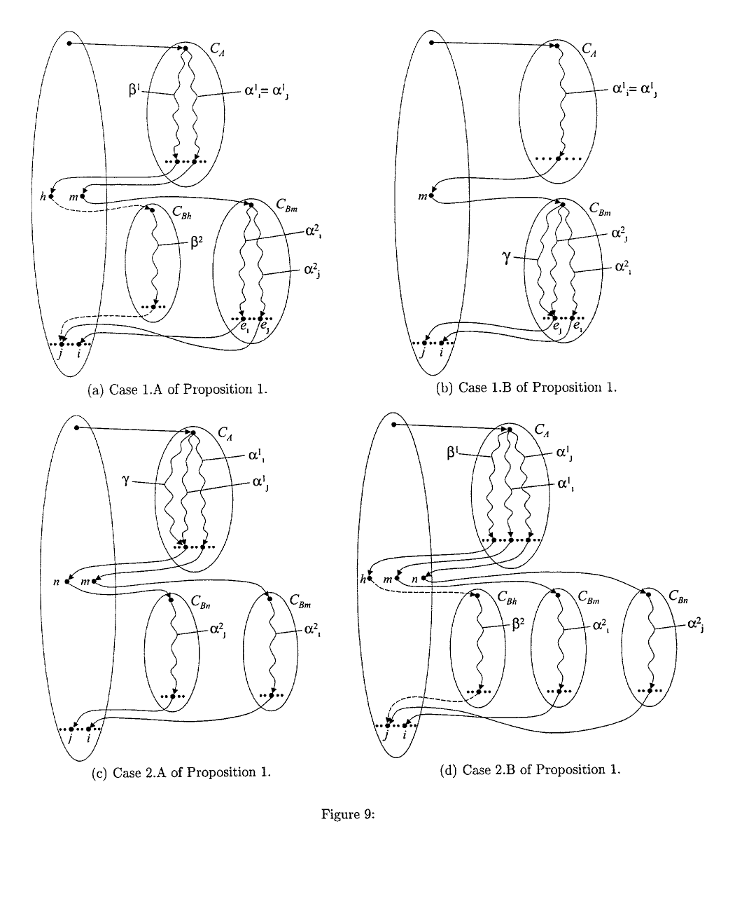

Case 1.A: Suppose that eᵢ<eⱼ in C_{B}_{ₘ} (see FIG. 9(a)). In this case, the return edges eᵢ [symbol] i and eⱼ→j “cross”. By Structural Invariant 2b, this can only happen if

There is a matched path corresponding to some assignment β¹ through C_{A} that leads to a middle vertex h, where h<m.

There is a matched path from h corresponding to some assignment ,β² through C_{B}_{ₕ}, (where C_{B}_{ₕ} could be CBₘ).

There is a return edge from the exit vertex reached by β² in C_{B}_{ₕ} to exit vertex j of C.

In this case, by the induction hypothesis applied to C_{A}, and the fact that h<m, it must be the case that we can choose β¹<αⱼ¹.

Consequently, β¹+β²<αⱼ¹+αⱼ², which contradicts the assumption that a αⱼ=αⱼ¹+αⱼ² is the least assignment in lexicographic order that leads to j.

Case 1.B: Suppose that eⱼ<eᵢ in C_{B}_{ₘ} (see FIG. 9(b)). Because αᵢ²<αⱼ² the induction hypothesis applied to C_{B}_{ₘ} implies that there must exist an assignment γ<αᵢ²<αⱼ² that leads to eⱼ. In this case, we have that αⱼ¹+γ<αᵢ¹+αⱼ²which again contradicts the assumption that α_{j=α}ⱼ¹+αⱼ² is the least assignment in lexicographic order that leads to j.

Case 2: αᵢ¹<αⱼ¹

Because αᵢ¹<αⱼ¹, the first halves of the matched paths followed during the interpretations of assignments αᵢ and αⱼ through C_{Λ} bring us to two different middle vertices of C, say m and n, respectively. The two paths then proceed through C_{B}_{ₘ} and C_{B}_{ₙ}, (where it could be the case that C_{B}_{ₘ}=C_{B}_{ₙ}), and return to i and j, respectively, where j<i. Again, there are two cases to consider:

Case 2.A: Suppose that n<m (see FIG. 9(c).) The argument is similar to Case 1.B above: By Structural Invariant 1, n<m means that the exit vertex reached by αⱼ¹ in C_{A} comes before the exit vertex reached by αᵢ¹ in C_{A}. By the induction hypothesis applied to C_{A}, there must exist an assignment γ<αᵢ¹<αⱼ¹ that leads to the exit vertex reached by αⱼ¹ in C_{A}. In this case, we have that γ+αⱼ²<αⱼ¹+αⱼ², which contradicts the assumption that αⱼ=αⱼ¹+αⱼ² is the least assignment in lexicographic order that leads to j.

Case 2.B: Suppose that m<n (see FIG. 9(d).) The argument is similar to Case 1.A above: By Structural Invariant 2, we can only have m<n and j<i if

There is a matched path corresponding to some assignment β¹ through C_{A} that leads to a middle vertex h, where h<m.

There is a matched path from h corresponding to some assignment β² through C_{B}_{ₕ} (where C_{B}_{ₕ} could be C_{B}_{ₘ}, or C_{B}_{ₙ}).

There is a return edge from the exit vertex reached by β² in C_{B}_{ₕ} to exit vertex j of C.

In this case, by the induction hypothesis applied to C_{A} and the fact that h<m<n it mast be the case that we can choose β¹ so that β¹<αⱼ¹.

Consequently, β¹+β²<αⱼ¹+αⱼ², which contradicts the assumption that αⱼ+αⱼ² is the least assignment in lexicographic order that leads to j.

In each of the cases above, we are able to derive a contradiction to the assumption that αⱼ is the least assignment in lexicographic order that leads to j. Thus, the supposition that the proposition does not hold for C cannot be true.

CANONICALNESS OF CFLOBDDS

We now turn to the issue of showing that CFLOBDDs are a canonical representation of functions over Boolean arguments. We must show three things:

1. Every level-k CFLOBDD represents a decision tree with 2²^{^{k}} leaves.

2. Every decision tree with ²^{^{k}} leaves is represented by some level-k CFLOBDD.

3. No decision tree with 2²^{^{k}} leaves is represented by more than one level-k CFLOBDD.

As described earlier, following a matched path (of length O(2^{k})) from the level-k entry vertex of a level-k CFLOBDD to a final value provides an interpretation of a Boolean assignment on 2^{k} variables. Thus, the CFLOBDD represents a decision tree with 2²^{^{k}} leaves (and Obligation 1 is satisfied).

To show that Obligation 2 holds, we describe a recursive procedure for constructing a level-k CFLOBDD from an arbitrary decision tree with 2²^{^{k}} leaves (i.e., of height 2^{k}). In essence, the construction shows how such a decision tree can be folded together to form a multi-terminal CFLOBDD.

The construction makes use of a set of auxiliary tables, one for each level, in which a unique representative for each class of equal proto-CFLOBDDs that arises is tabulated. We assume that the level-0 table is already seeded with a representative fork grouping and a representative don't-care grouping.

ALGORITHM 1 [DECISION TREE TO MULTI-TERMINAL CFLOBDD

1. The leaves of the decision tree are partitioned into some number of equivalence classes e according to the values that label the leaves. The equivalence classes are numbered 1 to e according to the relative position of the first occurrence of a value in a left-to-right sweep over the leaves of the decision tree. For Boolean-valued CFLOBDDs, when the procedure is applied at topmost level, there are at most two equivalence classes of leaves, for the values F and T. However, in general, when the procedure is applied recursively, more than two equivalence classes can arise.

For the general case of multi-terminal CFLOBDDs, the number of equivalence classes corresponds to the number of different values that label leaves of the decision tree.

2. (Base cases) If k=0 and e=1, construct a CFLOBDD consisting of the representative don't-care grouping, with a value tuple that binds the exit vertex to the value that labels both leaves of the decision tree.

If k=0 and e=2, construct a CFLOBDD consisting of the representative fork grouping, with a value tuple that binds the two exit vertices to the first and second values, respectively, that label the leaves of the decision tree.

If either condition applies, return the CFLOBDD so constructed as the result of this invocation; otherwise, continue on to the next step.

3. Construct—via recursive applications of the procedure—2²^{^{k-1}} level k-1 multi-terminal CFLOBDDs for the 2²^{^{k-1}} decision trees of height 2²^{^{k-1}} in the lower half of the decision tree.

These are then partitioned into some number e′of equivalence classes of equal multi-terminal CFLOBDDs; a representative of each class is retained, and the others discarded. Each of the 2²^{^{k-1}} “leaves” of the upper half of the decision tree is labeled with the appropriate equivalence-class representative for the subtree of the lower half that begins there. These representatives serve as the “values” on the leaves of the upper half of the decision tree when the construction process is applied recursively to the upper half in step 4.

The equivalence-class representatives are also numbered 1 to e′ according to the relative position of their first occurrence in a left-to-right sweep over the leaves of the upper half of the decision tree.

4. Construct—via a recursive application of the procedure—a level k-1 multi-terminal CFLOBDD for the upper half of the decision tree.

5. Construct a level-k multi-terminal proto-CFLOBDD from the level k-1 multi-terminal CFLOBDDs created in steps 3 and 4. The level-k grouping is constructed as follows:

(a) The A-connection points to the proto-CFLOBDD of the object constructed in step 4.

(b) The middle vertices correspond to the equivalence classes formed in step 3, in the order 1 . . . e′.

(c) The A-connection return tuple is the identity map back to the middle vertices (i.e., the tuple ]l..e′]).

(d) The B-connections point to the proto-CFLOBDDs of the e′ equivalence-class representatives constructed in step 3, in the order 1 . . . e′.

(e) The exit vertices correspond to the initial equivalence classes described in step 1, in the order 1. . . e′.

(f) The B-connection return tuples connect the exit vertices of the highest-level groupings of the equivalence-class representatives retained from step 3 to the exit vertices created in step 5e. In each of the equivalence-class representatives retained from step 3, the value tuple associates each exit vertex x with some value v, where 1≦v ≦e; x is now connected to the exit vertex created in step 5e that is associated with the same value v.

(g) Consult a table of all previously constructed level-k groupings to determine whether the grouping constructed by steps 5a-5f duplicate a previously constructed grouping. If so, discard the present grouping and switch to the previously constructed one; if not, enter the present grouping into the table.

6. Return a multi-terminal CFLOBDD created from the proto-CFLOBDD constructed in step 5 by attaching a value tuple that connects (in order) the exit vertices of the proto-CFLOBDD to the e values from, step 1.

FIG. 6(a) shows the decision tree for the function λx₀x₁x₂x₃.(x₀⊕x₁)V(x_{0 x} [symbol]₁ [symbol] x₂). FIG 6(b) shows the state of things after step 3 of Algorithm 1. Note that even though the level-1 CFLOBDDs for the first three leaves of the top half of the decision tree have equal proto-CFLOBDDs,⁷ the leftmost proto-CFLOBDD maps its exit vertex to F, whereas the exit vertex is mapped to T in the second and third proto-CFLOBDDs. Thus, in this case, the recursive call for the upper half of the decision tree (step 4) involves three equivalence classes of values. ⁷The equality of the proto-CFLOBDDs is detected in step 5g.

It is not hard to see that the structures created by Algorithm 1 obey the structural invariants that are required of CFLOBDDs:

Structural Invariant 1 holds because the A-connection return tuple created in step 5c of Algorithm 1 is the identity map.

Structural Invariant 2 holds because in steps 1 and 3 of Algorithm 1, the equivalence classes are numbered in increasing order according to the relative position of a value's first occurrence in a left-to-right sweep. This order is preserved in the exit vertices of each grouping constructed during an invocation of Algorithm 1 (cf. step 5f, and in particular, this gives rise to the “compact extension” property of Structural Invariant 2b.

Structural Invariant 3 holds because Algorithm 1 reuses the representative don't-care grouping and the representative fork grouping in step 2, and checks for the construction of duplicate groupings-and hence duplicate proto-CFLOBDDs--in step 5g.

Structural Invariant 4 holds because of steps 3, 5d, and 5f. On recursive calls to Algorithm 1, step 3 partitions the CFLOBDDs constructed for the lower half of the decision tree into equivalence classes of CFLOBDD values (i.e., taking into account both the proto-CFLOBDDs and the value tuples associated with their exit vertices). Therefore, in steps 5d and 5f, duplicate B-connection/return-tuple pairs can never arise.

Structural Invariant 5 holds because step 1 of Algorithm 1 constructs equivalence classes of values (ordered in increasing order according to the relative position of a value's first occurrence in a left-to-right sweep over the leaves of the decision tree).

Moreover, Algorithm 1 preserves interpretation under assignments: Suppose that C_{T} is the level-k CFLOBDD constructed by Algorithm 1 for decision tree T; it is easy to show by induction on k that for every assignment α on the 2^{k} Boolean variables x₀, . . . ,x₂_{⁻¹} the value obtained from C_{T} by following the corresponding matched path from the entry vertex of C_{T}'S highest-level grouping is the same as the value obtained for a from T. (The first half of α is used to follow a path through the A-connection of C_{T}, which was constructed from the top half of T. The second half of α is used to follow a path through one of the B-connections of C_{T}, which was constructed from an equivalence class of bottom-half subtrees of T; that equivalence class includes the subtree rooted at the vertex of T that is reached by following the first half of α.) Thus, every decision tree with 2²^{^{k}} leaves is represented by some level-k CFLOBDD in which meaning (interpretation under assignments) has been preserved; consequently, Obligation 2 is satisfied.

We now come to Obligation 3 (no decision tree with 2²^{^{L}} leaves is represented by more than one level-k CFLOBDD). The way we prove this is to define an unfolding process, called Unfold, that starts with a multi-terminal CFLOBDD and works in the opposite direction to Algorithm 1 to construct a decision tree; that is, Unfold (recursively) unfolds the A-connection, and then (recursively) unfolds each of the B-connections. (For instance, for the example shown in FIG. 6, Unfold would proceed from FIG. 6(c), to FIG. 6(b), and then to the decision tree for the function λx₀x₁x₂x₃.(x₀⊕x₁)V(x₀ [symbol] x₁ [symbol] 0 x₂) shown in FIG. 6(a).)

Unfold also preserves interpretation under assignments: Suppose that T_{C} is the decision tree constructed by Unfold for level-k CFLOBDD C; it is easy to show by induction on k that for every assignment α on the 2^{k} Boolcan variables x₀, . . . ,x₂_{^{k}}₋₁, the value obtained from C by following the corresponding reached path from the entry vertex of C's highest-level grouping is the same as the valse obtained for a from T_{C}. (The first half of α is used to follow a path through the A-connection of C, which Unfold unfolds into the top half of T_{C}. The second half of α is used to follow a path through one of the B-connections of C, which Unfold unfolds into one or more instances of bottom-half subtrees of T_{C}; that set of bottom-half subtrees includes the subtree rooted at the vertex of T that is reached by following the first half of α.)

Obligation 3 is satisfied if we can show that, for every CFLOBDD C, Algorithm 1 applied to the decision tree produced by Unfold (C) yields C again. To show this, we will define two notions of traces:

A Fold trace records the steps of Algorithm 1:

At step 1 of Algorithm 1, the decision tree is appended to the trace.

At the end of step 2 (if either of the conditions listed in step 2 holds), the level-0 CFLOBDD being returned is appended to the trace (and Algorithm 1 returns).

During step 3, the trace is extended according to the actions carried out by the folding process as it is applied recursively to each of the lower-half decision trees. (For purposes of settling Obligation 3, we will assume that the lower-half decision trees are processed by Algorithm 1 in left-to-right order.)

At the end of step 3, a hybrid decision-tree/CFLOBDD object (à la FIG. 6(b)) is appended to the trace.

During step 4, the trace is extended according to the actions carried out by the folding process as it is applied recursively to the upper half of the decision tree.

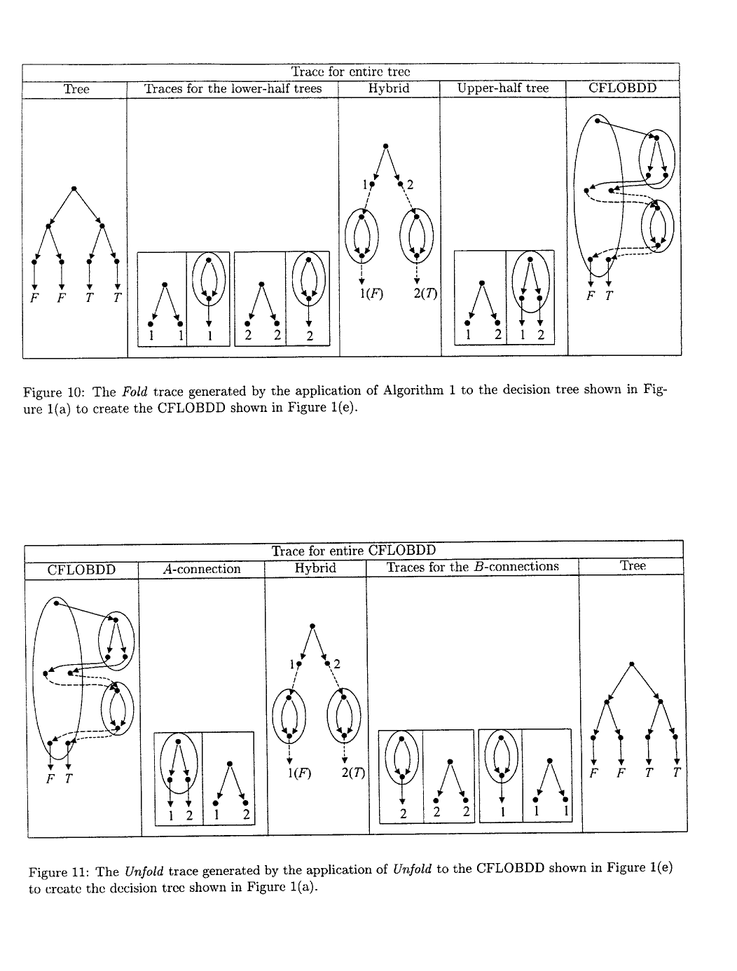

At the end of step 6, the CFLOBDD being returned is appended to the trace. For instance, FIG. 10 shows the Fold trace generated by the application of Algorithm 1 to the decision tree shown in FIG. 1(a) to create the CFLOBDD shown in FIG. 1(e).

An Unfold trace records the steps of Unfold(C):

CFLOBDD C is appended to the trace.

If C is a level-0 CFLOBDD, then a binary tree of height-1—with the leaves labeled according to C's value tuple—is appended to the trace (and the Unfold algorithm returns).

The trace is extended according to the actions carried out by Unfold as it is applied recursively to the A-connection of C.

A hybrid decision-tree/CFLOBDD object (à la FIG. 6(b)) is appended to the trace.

The trace is extended according to the actions carried out by Unfold as it is applied recursively to instances of B-connections of C. (For purposes of settling Obligation 3, we will assume that Unfold processes a separate instance of a B-connection for each leaf of the hybrid object's upper-half decision tree, and that the B-connections are processed in right-to-left order of the upper-half decision tree's leaves.)

Finally, the decision tree returned by Unfold is appended to the trace.

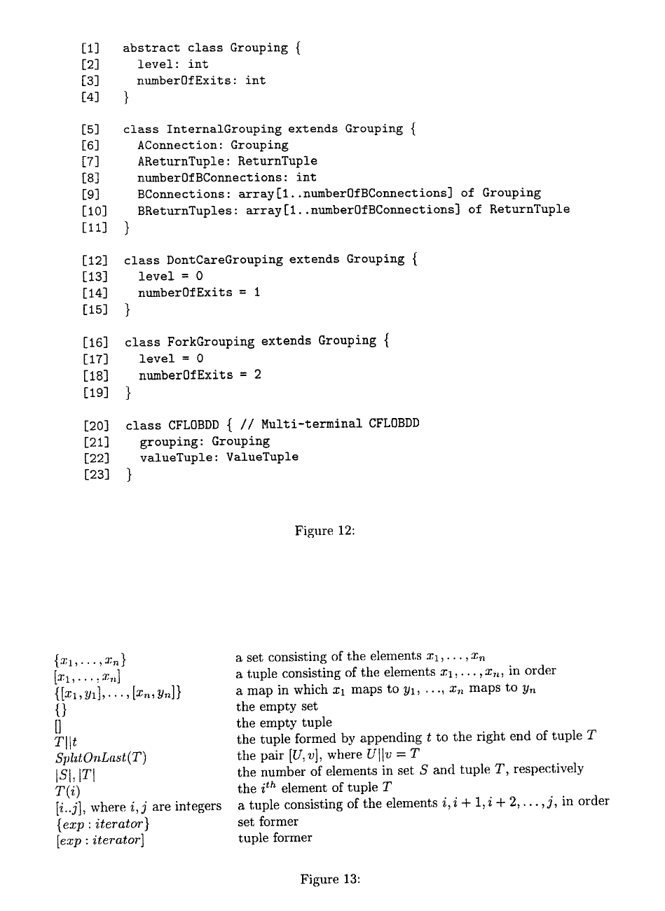

For instance, FIG. 11 shows the Unfold trace generated by the application of Unfold to the CFLOBDD shown in FIG. 1(e) to create the decision tree shown in FIG. 1(a).

Note how the Unfold trace shown in FIG. 11 is the reversal of the Fold trace shown in FIG. 11. We now argue that this property holds generally. (Technically, the argument given below in Proposition 2 shows that each element of an Unfold trace is structurally equal to the corresponding object in the Fold trace. However. Because Structural Invariant 3 and step 5g of Algorithm 1 both enforce the property that each CFLOBDD contains at most one instance of each grouping, this suffices to imply that that Obligation 3 is satisfied (and hence that a decision tree is represented by exactly one CFLOBDD).)

Proposition 2 Suppose that C is a multi-terminal CFLOBDD, and that Unfold(C) results in Unfold trace UT and decision tree To. Let C′ be the multi-terminal CFLOBDD produced by applying Algorithm 1 to T₀, and FT be the Fold trace produced during this process. Then

(i) FT is the reversal of UT.

(ii) C=C′,

Proof: Because C′ appears at the end of FT, and C appears at the beginning of UT, clause (i) implies (ii). We show (ii) by the following inductive argument:

Base case: The proposition is trivially true of level-0 CFLOBDDs. Given any pair of values v₁ and v₂ (such as F and T), there are exactly four possible level-0 CFLOBDDs: two constructed using a don't-care grouping—one in which the exit vertex is mapped to v₁, and one in which it is mapped to v₂—and two constructed using a fork grouping—one in which the two exit vertices are mapped to v₁ and v₂, respectively, and one in which they are mapped to v₂ and v₁. These unfold to the four decision trees that have 2²^{⁰}=2 leaves and leaf-labels drawn from {v₁, v₂}, and the application of Algorithm 1 to these decision trees yields the same level-0 CFLOBDD that we started with. (See step 2 of Algorithm 1.) Consequently, the Fold trace FT and the Unfold trace UT are reversals of each other.

Induction step: The induction hypothesis is that that the proposition holds for every level-k multi-terminal CFLOBDD. We need to argue that the proposition extends to level k+1 multi-terminal CFLOBDDs.

First, note that the induction hypothesis implies that each decision tree with 2²^{^{k}} leaves is represented by exactly one level-k CFLOBDD. We will refer to this as the corollary to the induction hypothesis.

Unfold trace UT can be divided into five segments:

(u1) C itself

(u2) the Unfold trace for C's A-connection

(u3) a hybrid decision-tree/CFLOBDD object (call this object D)

(u4) the Unfold trace for C's B-connections

(u5) T₀.

Fold trace FT can also be divided into five segments:

(f1l) T₀

(f2) the Fold trace for T₀'s lower-half trees

(f3) a hybrid decision-tree/CFLOBDD object (call this object D′)

(f4) the Fold trace for T₀'s upper-half

(f5) C′.

Clearly, (u1) is equal to (f5); our goal is to show that (u2) is the reversal of (f4); (u3) is equal to (f3); (u4) is the reversal of (f2); and (u5) is equal to (f1).

(u3) is equal to (f3) Consider the hybrid decision-tree/CFLOBDD object D obtained after Unfold has finished unfolding C's A-connection.⁸ The upper part of D (the decision-tree part) came from the recursive invocation of Unfold, which produced a decision tree for the first half of the Boolean variables, in which each leaf is labeled with the index of a middle vertex from the level k+1 grouping of C (e.g., see FIG. 6(b)). ⁸The A-connection is actually a proto-CFLOBDD, whereas Unfold works on multi-terminal CFLOBDDs. However, the A-connection return tuple (with the indices of the middle vertices as the value space) serves as the value tuple whenever we wish to consider the A-connection as a multi-terminal CFLOBDD.

As a consequence of Proposition 1, together with the fact that Unfold preserves interpretation under assignments, the relative position of the first occurrence of a label in a left-to-right sweep over the leaves of this decision tree reflects the order of the level k+1 grouping's middle vertices.⁹ However, each middle vertex has an associated B-connection, and by Structural Invariants 2, 4, and 5, the middle vertices can be thought of as representatives for a set of pairwise non-equal CFLOBDDs (that themselves represent lower-half decision trees). ⁹This is where the argument breaks down if we attempt to apply the same argument to FIG. 8(b): In this case, the labels on the leaves of D, in left-to-right order, would be 2 and 1.

Fold trace FT also has a hybrid decision-tree/CFLOBDD object, namely D′. The crucial point is that the action of partitioning T₀'s lower-half CFLOBDDs that is carried out in step 3 of Algorithm 1 also results in a labeling of each leaf of the upper-half's decision tree with a representative of an equivalence class of CFLOBDDs that represent the lower half of the decision tree starting at that point.

By the corollary to the induction hypothesis, the 2²^{^{k}} bottom-half trees of T₀ are represented uniquely by the respective CFLOBDDs in D′. Similarly, by the corollary to the induction hypothesis, the 2²^{^{k}} CFLOBDDs used as labels in D uniquely represent the respective bottom-half trees of T₀. Thus, the labelings on D and D′ must be the same.

(u2) is the reversal of (f4); (u4) is the reversal of (f2) Given the observation that D=D′, these follow in a straightforward fashion from the inductive hypothesis (applied to the A-connection and the B-connections of C).

(u5) is equal to (f1) Because (u2) is the reversal of (f4) and (u4) is the reversal of (f2), we know that the level-k proto-CFLOBDDs out of which the level k +1 grouping of C′ is constructed are the same as the level-k proto-CFLOBDDs that make up the A-connection and B-connections of C.

We already argued that steps 5 and 6 of Algorithm 1 lead to CFLOBDDs that obey the five structural invariants required of CFLOBDDs. Moreover, there is only one way for Algorithm I to construct the level k+1 grouping of C′ so that Structural Invariants 2, 3, and 4 are satisfied. Therefore, C=C′.

In summary, we have now shown that Obligations 1, 2, and 3 are all satisfied. This implies that each decision tree with 2²^{^{k}} leaves is represented by exactly one level-k CFLOBDD—i.e., CFLOBDDs are a canonical representation of functions over Boolean arguments.

REPRESENTING MULTI-TERMINAL CFLOBDDS IN A COMPUTER MEMORY

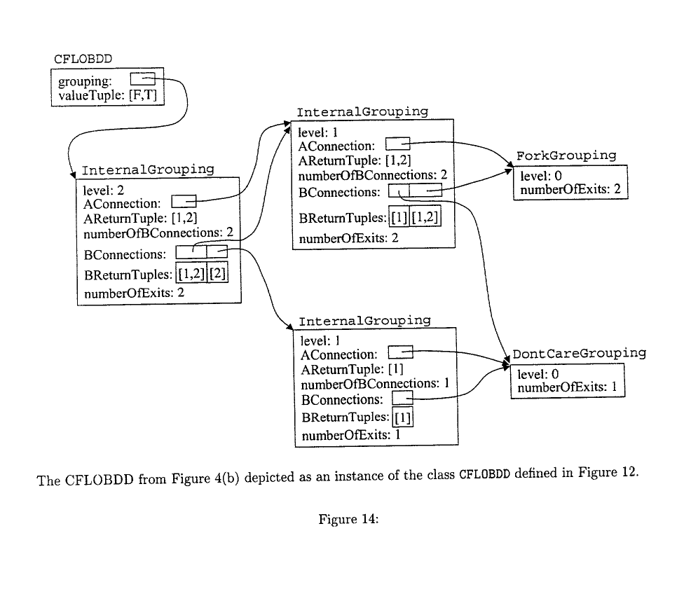

An object-oriented pseudo-code will be used to describe the representations of CFLOBDDs in a computer memory and operations on them. The basic classes that are used for representing multi-terminal CFLOBDDs in a computer memory are defined in FIG. 12, which provides specifications of classes Grouping, InternalGrouping, DontCareGrouping, ForkGrouping, and CFLOBDD.

A few words are in order about the notation used in the pseudo-code:

A Java-like semantics is assumed. For example, an object or field that is declared to be of type InternalGrouping is really a pointer to a piece of heap-allocated storage. A variable of type InternalGrouping is declared and initialized to a new InternalGrouping object of level k by the declaration

InternalGrouping g=new InternalGrouping(k)

Procedures can return multiple objects by returning tuples of objects, where tupling is denoted by square brackets. For instance, if f is a procedure that returns a pair of ints—and, in particular, if f (3) returns a pair consisting of the values 4 and 5—then int variables a and b would be assigned 4 and 5 by the following initialized declaration:

int×int [a,b] f(3)

The indices of array elements start at 1.

Arrays are allocated with an initial length (which is allowed to be 0); however, arrays are assumed to lengthen automatically to accommodate assignments at index positions beyond the current length.

We assume that a call on the constructor InternalGrouping(k) returns an InternalGrouping in which the members have been initialized as follows:

level=k

AConnection=NULL

AReturnTuple=NULL

numberOfBConnections=0

BConnections=new array[0] of Grouping

BReturnTuples=new array[0] of ReturnTuple

numberOfExits=0

Similarly, we assume that a call on the constructor CFLOBDD(g,vt) returns a CFLOBDD in which the members have been initialized as follows:

grouping=g

valueTuple=vt

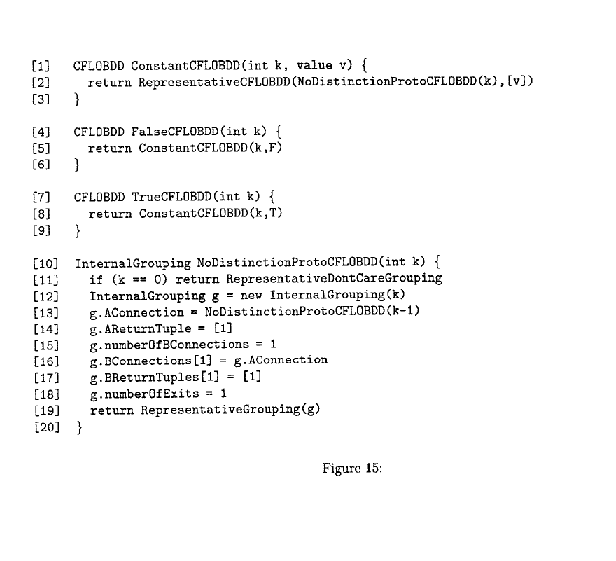

To be able to state the algorithms for CFLOBDD operations in a concise manner, a variety of set-valued and tuple-valued expressions will be used, using notation inspired by the SETL language [Dew79, SDDS87]. FIG. 13 lists the set operations and tuple operations that are used to express the algorithms for CFLOBDD operations. An iterator specifies what elements are collected in a set-former expression of the form {exp: iterator} or in a tuple-former expression of the form [exp:iterator] (cf. [Dew79, Sections 1.8 and 5.2]).

An iterator creates a sequence of candidate bindings for one of more identifiers used in the iterator (the iteration variables).

The expression of the iterator is evaluated with respect to each candidate binding. In the case of a tuple former, the resulting value is placed at the right end of the tuple being formed; in the case of a set former, the value is placed in the set being formed, unless it duplicates a value already there.

Compound iterators are formed by writing a list of basic iterators, separated by commas. The effect is to define a kind of loop nest: the last iterator in the sequence generates its candidate values most rapidly; the first iterator generates values least rapidly.

An iterator can also be followed by a qualifier of the form “|condition”, which has the effect of performing a test for each candidate binding of values to the iteration variables. If the value of the condition is false, then the candidate binding is skipped, and the iterator moves on to the next candidate binding, without placing an element into the set or tuple.

Thus, set formers and tuple formers are very similar, except that values are placed into a tuple in a specific order. Tuples may contain duplicate elements; sets may not. For example,

{x²:x ∈[1..5]}={1,4,9,16,25}

{x²:x∈[1..5]|even(x)}={4,16}

{x×y:x∈[1..3],y∈[1..3]}={1,2,3,4,6,9}

[x²:x∈[1..5]]=[1,4,9,16,25]

[x²:x∈[1..5]|even(x)]=[4,16]

[x×y:x∈[1..3], y∈[1..3]]=[1,2,3,2,4,6,3,6,9]

[[x,y]:x∈[1..3],y∈[1..3]]=[[1,1],[1,2],[1,3],[2,1],[2,2],[2,3],[3,1], [3,2],[3,3]]

Finally, if T is the tuple [2, 2, 1, 1, 4, 1, 1], then the expression

[T(i):i∈[1..|T|]|i=min{j ∈[1..|T|]|T(j)=T(i)}] (1)

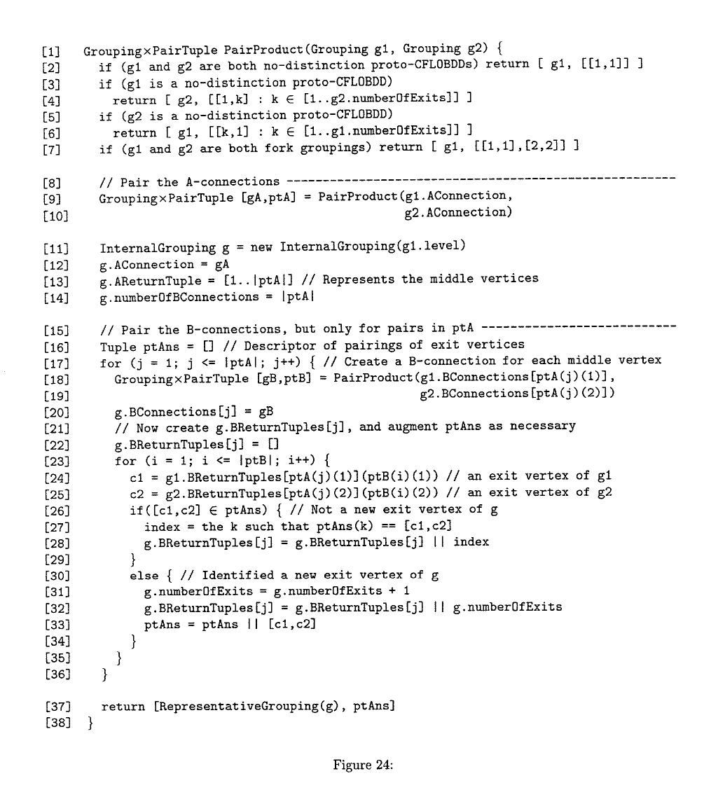

evaluates to the tuple [2, 1, 4]. In essence, expression (1) says to retain the leftmost occurrence of a value in T as the representative of the set of elements in T that have that value. For instance, the 2 in the first position of T contributes the 2 to [2,1,4] because 1=min{j ∈[1..|T|]|T(j)=2};however, the 2 in the second position of T does not contribute a value to [2,1,4] because 2≠min {j ∈[1..|T|]|T(j)=2}.Similarly, the 1 in the third position of T contributes the 1 to [2, 1, 4] because 3 =min{j ∈[1..|T|]|T(j) =1}, and the 4 in the fifth position of T contributes the 4 [2, 1, 4]because 5=min{j ∈[1..|T|]|T(j)=4}. (Expression (1) is used in one of the algorithms that operates on CFLOBDDs in a certain computation that is carried out to maintain the CFLOBDD structural invariants; cf. lines [4]-[8] of FIG. 22.)

The class definitions of FIG. 12, as well as the algorithms for the core CFLOBDD operations-defined in FIGS. 22, 23, 24 25, 26, and 27—make use of the following auxiliary classes:

A ReturnTuple is a finite tuple of positive integers.

A PairTuple is a sequence of ordered pairs.

A TripleTuple is a sequence of ordered triples.

A ValueTuple is a finite tuple of whatever values the multi-terminal CFLOBDD is defined over.

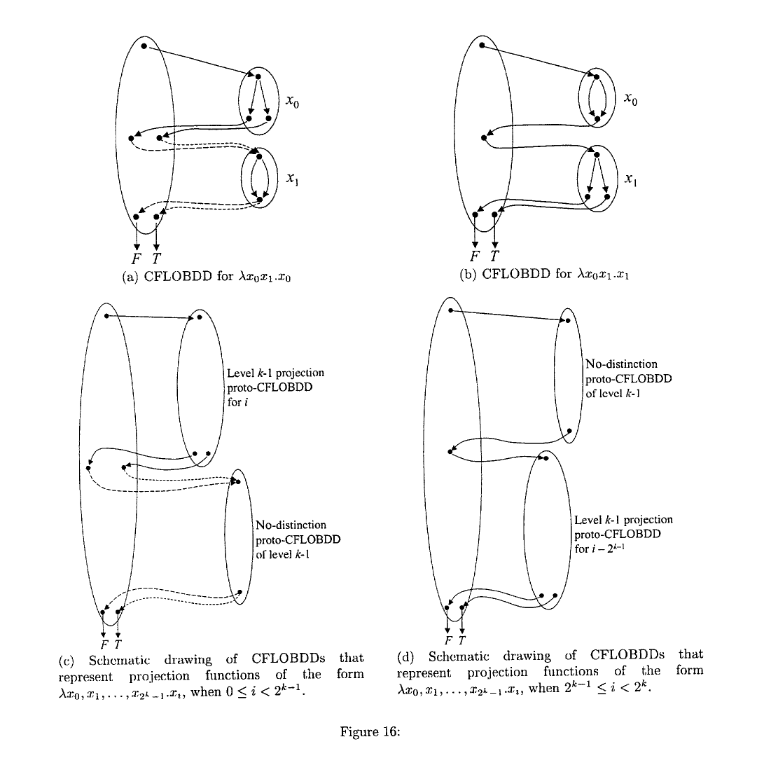

FIG. 14 shows how the CFLOBDD from FIG. 4(b) would be represented as an instance of class CFLOBDD.

MEMOIZATION OF CFLOBDDS AND GROUPINGS

A memo function for F, where F is either a function (i.e., a procedure with no side-effects) or a construction operation, is an associative-lookup table—typically a hash table—of pairs of the form [x, F(x)], keyed on the value of x. The table is consulted each time F is applied to some argument (say x₀); if F has already been called with argument x₀, then [x₀,F(x₀)] is retrieved from the table, and the second component, F(x₀), is returned as the result of the function call. This saves the cost of reperforming the computation of F(x₀) (at the expense of performing a lookup on x₀).

In the case where F is a construction operation for a hierarchically structured datatype, memoization can be used to maintain the invariant that only a single representative is ever constructed for each value—or, more precisely, for each equivalence class of data structures that represent a given datatype value. At the cost of maintaining this invariant at construction time (which typically means the cost of a hash lookup), this technique allows equality testing to be performed in constant time, by means of a single operation that compares two pointers.

In the case of Groupings and CFLOBDDs, we will use memoization to enforce such an invariant over all operations that construct objects of these classes.¹⁰ Because the operations that construct Groupings and ¹⁰speed up certain operations, it can also be useful to construct memo functions for the objects of classes ReturnTuple, CFLOBDDs involve a certain amount of processing before the object being constructed is finally complete (cf. FIGS. 24 and 25), we will assume that two operations are available for explicitly maintaining the tables of representative Groupings and CFLOBDDs, named RepresentativeGrouping and RepresentativeCFLOBDD, respectively. For instance, a call RepresentativeGrouping(g) checks to see whether a representative for g is already in the table of representative Groupings; if there is such a representative, say h, then g is discarded and h is returned as the result; if there is no such representative, then g is installed in the table and returned as the result. The operations RepresentativeForkGrouping and RepresentativeDontCareGrouping return the memoized representatives of types ForkGrouping and DontCareGrouping, respectively.

Operations that create InternalGroupings, such as PairProduct (FIG. 24) and Reduce (FIG. 25), have the following form:

Operation() {
...
InternalGrouping g = new InternalGrouping(k)
...
// Operations to fill in the members of g, including g.AConnection and the
// elements of array g.BConnections, with level k-1 Groupings
...
return RepresentativeGrouping(g)
}

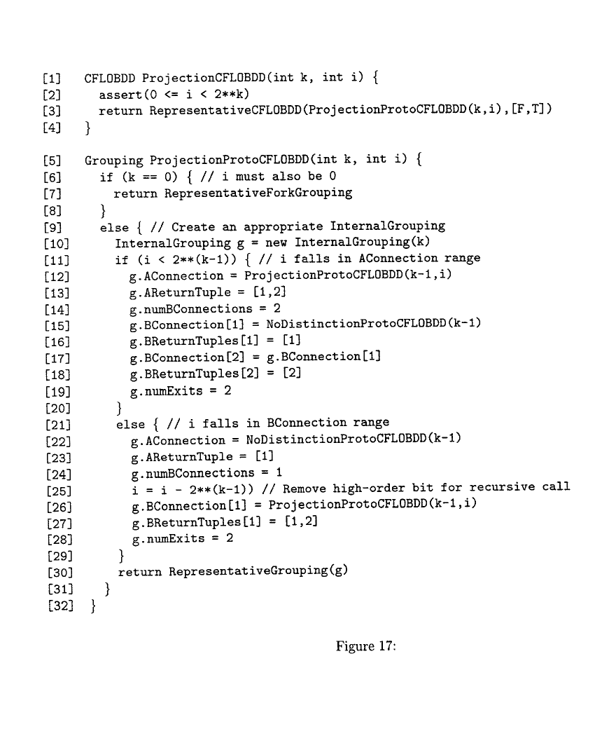

The operation NoDistinctionProtoCFLOBDD shown in FIG. 15, which constructs the members of the family of no-distinction proto-CFLOBDDs depicted in FIG. 7, also has this form.

The operation ConstantCFLOBDD shown in lines [1]-[3] of FIG. 15 illustrates the use of RepresentativeCFLOBDD: ConstantCFLOBDD(k,v) returns a memoized CFLOBDD that represents a constant function of the form λx₀, x₁, . . . , x₂_{⁻¹}.v.

EQUALITY OF CFLOBDDS AND GROUPINGS

Because of the use of memoization, it is possible to test whether two variables of type CFLOBDD are equal by performing a single pointer comparison. Because CFLOBDDs are a canonical representation of functions over Boolean arguments, this means that it is possible to test whether two variables of type CFLOBDD hold the same function by performing a single pointer comparison.

This property is important in user-level applications in which various kinds of data are implemented using class CFLOBDD. In applications structured as fixed-point-finding loops, for example, this property provides a unit-cost test for whether the fixed-point has been found.

Because of the use of memoization, it is also possible to test whether two variables of type Grouping are equal by performing a single pointer comparison. Because each grouping is always the highest-level grouping of some proto-CFLOBDD; the equality test on Groupings is really a test of whether two proto-CFLOBDDs are equal. The property of being able to test two proto-CFLOBDDs for equality quickly is important because proto-CFLOBDD equality tests are necessary for maintaining the structural invariants of CFLOBDDs.

PRIMITIVE OPERATIONS FOR INSTANTIATING MULTI-TERMINAL CFLOBDDS

Algorithm 1 creates a multi-terminal CFLOBDD, starting from a fully instantiated decision tree. In many applications, however, the decision trees for various functions of interest are much too large to be instantiated explicitly. In these circumstances, Algorithm 1 represents only a conceptual method for creating CFLOBDDs, not one that can be used in practice.

As is also done with BDDs, one can often avoid the need to instantiate decision trees in these situations: certain primitive operations are invoked to directly create CFLOBDDs that represent certain (usually simple) functions; thereafter, one works only with CFLOBDDs-constructing CFLOBDDs for other functions of interest by applying CFLOBDD-combining operations. The need to instantiate decision trees is sidestepped by using CFLOBDD-combining operations that build their result CFLOBDDs directly from the constituents PairTuple, and ValueTuple.

However, our descriptions of the core algorithms for manipulating Groupings and CFLOBDDs will not go into this level of detail, because the use of such techniques to tune the performance of an implementation can be considered to be part of the standard repertoire of programming techniques, and hence does not represent an innovative activity for a person skilled in the computer arts. of the CFLOBDDs that are the arguments to the operation (and, in particular, without having to instantiate full decision trees for either the argument CFLOBDDs or the result CFLOBDD).

For OBDDs, among the combining operations that have been found to be useful are Boolean operations (e.g., [symbol] , V, etc.), if-then-else, restriction, composition, satisfy-one, satisfy-all, and satisfy-count [Bry86, BRB90]. For Multi-Terminal BDDs, among the combining operations that have been found to be useful are absolute value, scalar multiplication, addition and other arithmetic operations, sorting a vector of integers, summing a matrix over one dimension, matrix multiplication, and finding the set of assignments that satisfy an arithmetic relation f_{1 ˜f}₂, where ˜is one of =, ≠, <, <, >, or >[CMZ⁺93, CFZ95a ].

The algorithms for the corresponding CFLOBDD operations (both primitive operations and combining operations) are different from their BDD counterparts [Bry86, BRB90, CMZ⁺93, CFZ95a]; in general, they are somewhat more complicated than their BDD counterparts (due mainly to the need to maintain Structural Invariants 1-5, which are more complicated than the structural invariants of BDDS).

Some of the CFLOBDD-combining operations are discussed later, in the sections titled “Binary Operations on Multi-Terminal CFLOBDDs” and “Ternary Operations on Multi-Terminal CFLOBDDs”. In the remainder of this section, we discuss primitive CFLOBDD-creation operations, which directly create CFLOBDDs that represent certain simple functions.

Examples of useful primitive CFLOBDD-creation operations include

The constant functions of the form λx₀, x₁, . . . , x₂_{^{k}}₋₁.v. Pseudo-code for constructing CFLOBDDs that represent these functions is given by the operation ConstantCFLOBDD, shown in FIG. 15. For instance, ConstantCFLOBDD can be used to construct Boolean-valued CFLOBDDs that represent the constant functions of the form λx₀, x₁, . . . , x₂_{^{k}}₋₁.F and λx₀, x₁, . . . , x₂_{^{k}}₋₁ .T (see lines [4]-[6] and [7]-[9] of FIG. 15).

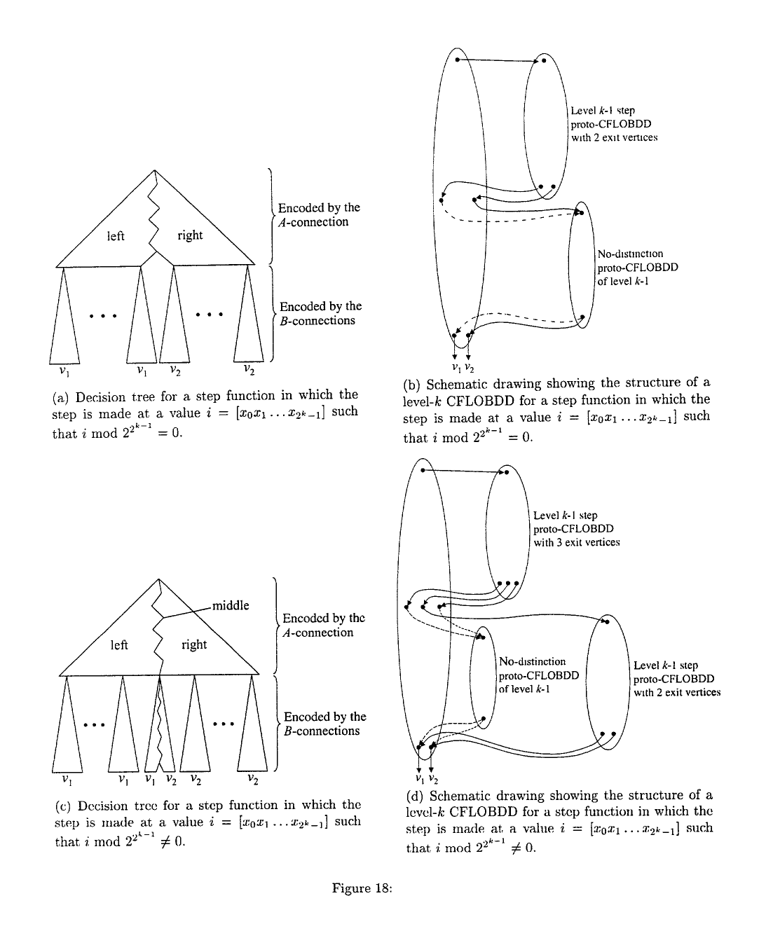

The Boolean-valued projection functions of the form λx₀, x₁, . . . , x₂_{^{L}}₋₁.xᵢ, where i ranges from 0 to 2^{k}-1. FIG. 16 illustrates the structure of the CFLOBDDs that represent these functions, and FIG. 17 gives pseudo-code for constructing Boolean-valued CFLOBDDs that represent them.

The step functions of the form

$$λ {x}_{0} , {x}_{1} , … , {{x}_{{2}^{k}}}_{- 1} \cdot \{ \begin{matrix} {v}_{1} if the number whose bits are {x}_{0} {x}_{1} {{…x}_{{2}^{k}}}_{- 1} is strictly less than i \\ {v}_{2} if the number whose bits are {x}_{0} {x}_{1} {{…x}_{{2}^{k}}}_{- 1} is greater than or equal to i \end{matrix}$$

where i ranges from 0 to 2²^{^{k}} FIG. 19 presents pseudo-code for constructing CFLOBDDs that represent these functions.

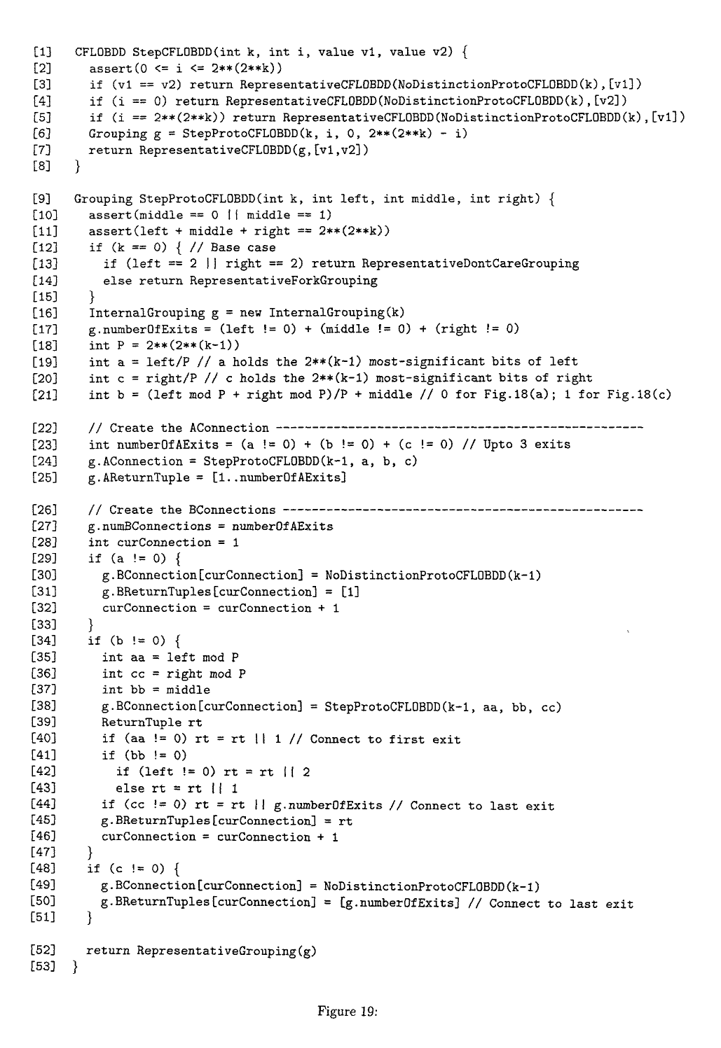

It is helpful to think of a step function in terms of a decision tree (cf. FIG. 18). In the decision tree, all leaves to the left of some point are labeled with v₁; all leaves to the right of that point are labeled with v₂. The first occurrence of v₂—the point at which values make the step from v₁ to v₂—is associated with an assignment α on the 2^{k} Boolean variables x₀, . . . , x₂_{^{k}}₋₁. This corresponds to a binary numeral i, defined by i=α(x₀)α(x₁) . . . α(x₂_{^{k}}₋₁).

The recursive structure of function StepProtoCFLOBDD of FIG. 19 is complicated by the following issue:

When i mod 2²^{^{k-1}}=0, there is a “clean split” in the top half of the decision tree (see FIG. 18(a)). In this case, there should be exactly two B-connections in the constructed proto-CFLOBDD, both to the no-distinction proto-CFLOBDD of level k-1 (see FIG. 18(b)).

When i mod 2²^{^{k-1}}≠0, there is not a clean split in the top half of the decision tree (see FIG. 18(c)). In the general case, depicted in FIG. 18(d), the A-connection proto-CFLOBDD must make a three-way split, according to the variables a, b, and c of StepProtoCFLOBDD (which are rebound to left, middle, and right in the recursive call to StepProtoCFLOBDD in line [24] of FIG. 19).

Note that the portion of the decision tree that corresponds to middle is limited in size, compared to the portions that correspond to left and right: for a given level A, which corresponds to a decision tree of height 2^{k}, middle corresponds to a single one of the lower-half subtrees of height 2^{k-1} (see FIG. 18(c)). (Accordingly, in function StepProtoCFLOBDD, variable middle can only take on the value 0 or 1.)

The further splitting of the part of the decision tree that corresponds to middle is carried out in building the corresponding B-connection (see lines [34]-[47] of FIG. 19).

Each of the B-connections that correspond to left and right do not involve any further splitting; hence, these and are connected directly to NoDistinctionProtoCFLOBDDs (see lines [29]-[33] and [48]-[51] of FIG. 19).

The reason for the somewhat complicated structure of the code in lines [29]-[51] of FIG. 19 is due to the fact that it is possible for either left or right to be 0 on some recursive calls to StepProtoCFLOBDD.

Several other primitive operations that directly create multi-terminal CFLOBDDs are discussed later, in the section titled “Representing Spectral Transforms with Multi-Terminal CFLOBDDs”. (The operations discussed there create CFLOBDDs that represent certain interesting families of matrices.)

UNARY OPERATIONS ON MULTI-TERMINAL CFLOBDDS

This section discusses how to perform certain unary operations on multi-terminal CFLOBDDs:

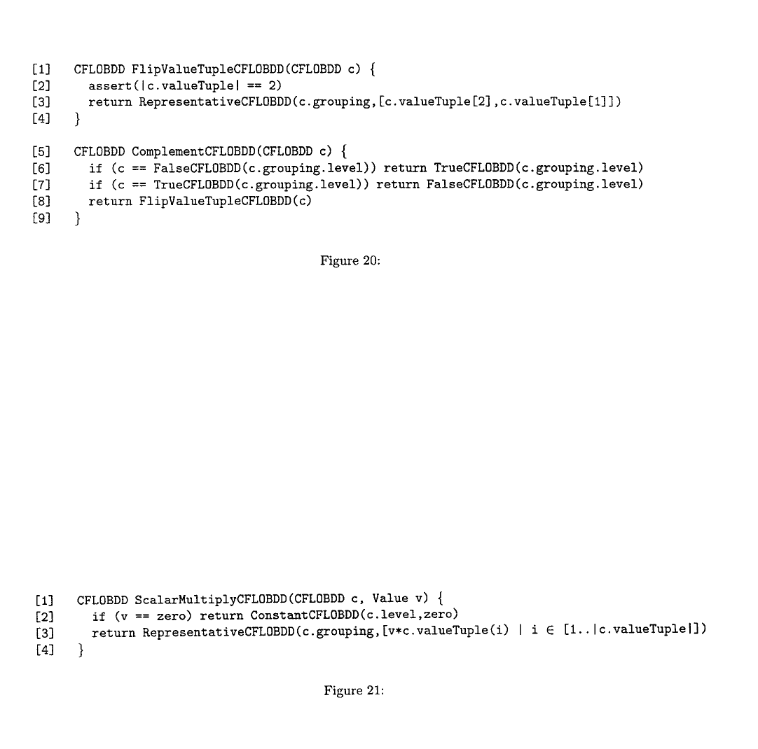

Function FlipValueTupleCFLOBDD of FIG. 20 applies in the special situation in which a CFLOBDD maps Boolean-variable-to-Boolean-value assignments to just two possible values; FlipValueTupleCFLOBDD flips the two values in the CFLOBDD's valueTuple field and returns the resulting CFLOBDD. In the case of Boolean-valued CFLOBDDs, this operation can be used to implement the operation ComplementCFLOBDD, which forms the Boolean complement of its argument, in an efficient manner.

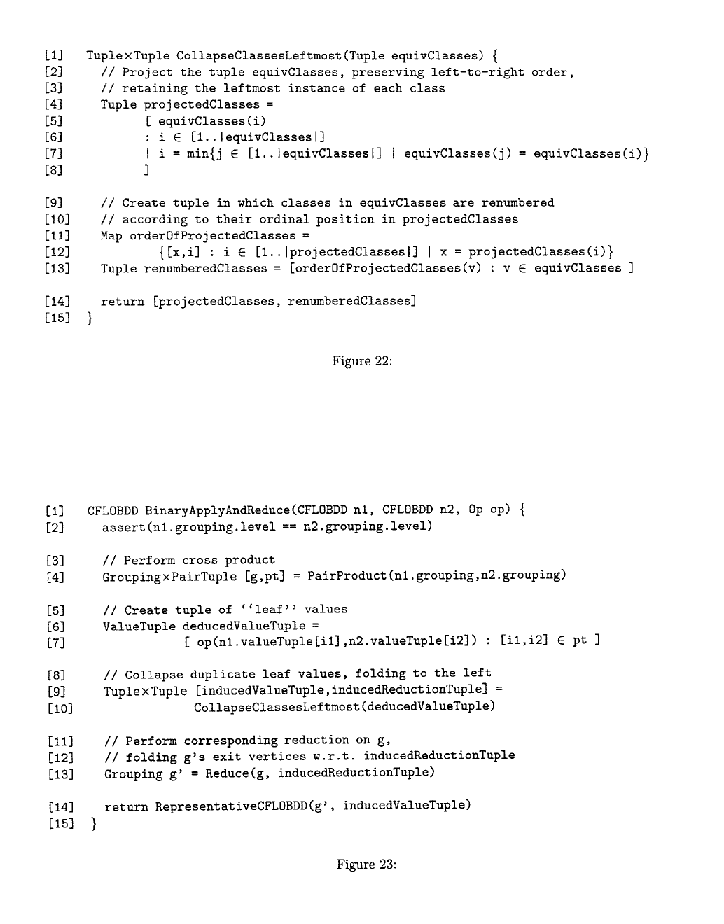

Function ScalarMultiplyCFLOBDD of FIG. 21 applies to any CFLOBDD that maps Boolean-variable-to-Boolean-value assignments to values on which multiplication by a scalar value of type Value is defined. When Value argument v of ScalarMultiplyCFLOBDD is the special value zero, a constant-valued CFLOBDD that maps all Boolean-variable-to-Boolean-value assignments to zero is returned.

BINARY OPERATIONS ON MULTI-TERMINAL CFLOBDDS

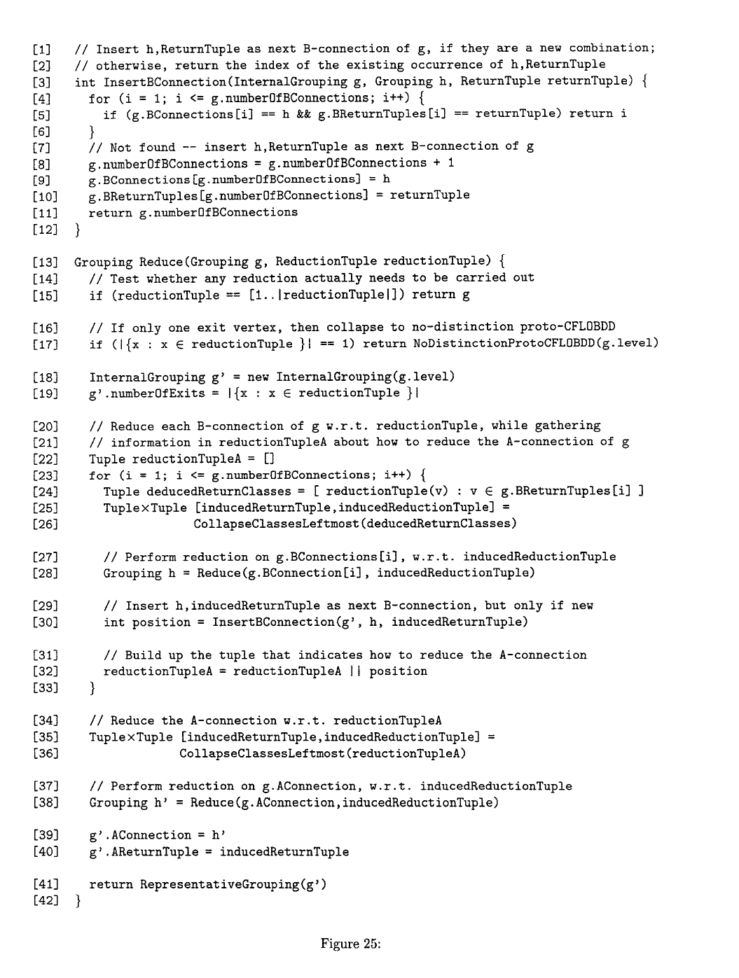

This section discusses how to perform binary operations on multi-terminal CFLOBDDs. FIG. 22, 23, 24, and 25 present the core algorithms that are involved. (In FIGS. 23 and 24, we assume the CFLOBDD or Grouping arguments are objects whose highest-level groupings are all at the same level.)

The operation BinaryApplyAndReduce given in FIG. 23 starts with a call on PairProduct. (See lines [3]-[4].) The operation PairProduct, which is given in FIG. 24, performs a recursive traversal of the two Grouping arguments, g1 and g2, to create a proto-CFLOBDD that represents a kind of cross product. PairProduct returns the proto-CFLOBDD formed in this way (g), as well as a descriptor (pt) of the exit vertices of g in terms of pairs of exit vertices of the highest-level groupings of g1 and g2. (See FIG. 24, lines [2]-[7] and [23]-[35].) From the semantic perspective, each exit vertex e₁ of g₁ represents a (non-empty) set A₁ of variable-to-Boolean-value assignments that lead to e₁ along a matched path in g₁; similarly, each exit vertex e₂ of g2 represents a (non-empty) set of variable-to-Boolean-value assignments A₂ that lead to e₂ along a matched path in g2. If pt, the descriptor of g's exit vertices returned by PairProduct, indicates that exit vertex e of g corresponds to [e₁, e₂], then e represents the (non-empty) set of assignments A₁ ∩A₂.

BinaryApplyAndReduce then uses pt, together with op and the value tuples from CFLOBDDs n1 and n2, to create the tuple deducedValueTuple of leaf values that should be associated with the exit vertices. (See FIG. 23, lines [5]-[7].)

However, deducedValueTuple is a tentative value tuple for the constructed CFLOBDD; because of Structural Invariant 5, this tuple needs to be collapsed if it contains duplicate values.

BinaryApplyAndReduce obtains two tuples, inducedValueTuple and inducedReductionTuple, which describe the collapsing of duplicate leaf values, by calling the subroutine CollapseClassesLeftmost:

Tuple inducedValueTuple serves as the final value tuple for the CFLOBDD constructed by BinaryApplyAndReduce. In inducedValueTuple, the leftmost occurrence of a value in deducedValueTuple is retained as the representative for that equivalence class of values. For example, if deducedValueTuple is [2, 2, 1, 1, 4, 1, 1], then inducedValueTuple is [2, 1, 4]. The use of leftward folding is dictated by Structural Invariant 2b.

Tuple inducedReductionTuple describes the collapsing of duplicate values that took place in creating inducedValueTuple from deducedValueTuple: inducedReductionTuple is the same length as deducedValueTuple, but each entry inducedReductionTuple(i) gives the ordinal position of deducedValueTuple(i) in inducedValueTuple. For example, if deducedValueTuple is [22,1,1,4,1,1] (and thus inducedValueTuple is [2,1,4]), then inducedReductionTuple is [1, 1, 2, 2, 3, 2, 2]—meaning that positions 1 and 2 in deducedValueTuple were folded to position 1 in inducedValueTuple, positions 3, 4, 6, and 7 were folded to position 2 in inducedValueTuple, and position 5 was folded to position 3 in inducedValueTuple.

(See FIG. 23, lines [8]-[10], as well as FIG. 22.)

Finally, BinaryApplyAndReduce performs a corresponding reduction on Grouping g, by calling the subroutine Reduce, which creates a new Grouping in which g's exit vertices are folded together with respect to tuple inducedReductionTuple. (See FIG. 23, lines [11]-[13].)

Procedure Reduce, shown in FIG. 25, recursively traverses Grouping g, working in the backwards direction, first processing each of g's B-connections in turn, and then processing g's A-connection. In both cases, the processing is similar to the (leftward) collapsing of duplicate leaf values that is carried out by BinaryApplyAndReduce:

In the case of each B-connection, rather than collapsing with respect to a tuple of duplicate final values, Reduce's actions are controlled by its second argument, reductionTuple, which clients of Reduce—namely, BinaryApplyAndReduce and Reduce itself—use to inform Reduce how g's exit vertices are to be folded together. For instance, the value of reductionTuple could be [1, 1, 2,2, 3, 2, 2]—meaning that exit vertices 1 and 2 are to be folded together to form exit vertex 1, exit vertices 3, 4, 6, and 7 are to be folded together to form exit vertex 2, and exit vertex 5 by itself is to form exit vertex 3.

In FIG. 25, line [24], the value of reductionTuple is used to create a tuple that indicates the equivalence classes of targets of return edges for the B-connection under consideration (in terms of the new exit vertices in the Grouping that will be created to replace g).

Then, by calling the subroutine CollapseClassesLeftmost, Reduce obtains two tuples, inducedReturnTuple and inducedReductionTuple, that describe the collapsing that needs to be carried out on the exit vertices of the B-connection under consideration. (See FIG. 25, lines [24]-[26].) Tuple inducedReductionTuple is used to make a recursive call on Reduce to process the B-connection; inducedReturnTuple is used as the return tuple for the Grouping returned from that call. Note how the call on InsertBConnection in line [30] of Reduce enforces Structural Invariant 4. (See also FIG. 25, lines [1]-[12].)

As the B-connections are processed, Reduce uses the position information returned from InsertBConnection to build up the tuple reductionTupleA. (See FIG. 25, line [32].) This tuple indicates how to reduce the A-connection of g.

Finally, via processing similar to what was done for each B-connection, two tuples are obtained that describe the collapsing that needs to be carried out on the exit vertices of the A-connection, and an additional call on Reduce is carried out. (See FIG. 25, lines [34]-[40].)

Recall that a call on RepresentativeGrouping(g) may have the side effect of installing g into the table of memoized Groupings. We do not wish for this table to ever be polluted by non-well-formed proto-CFLOBDDs. Thus, there is a subtle point as to why the grouping g constructed during a call on PairProduct meets Structural Invariant 4—and hence why it is permissible to call RepresentativeGrouping(g) in line [37] of FIG. 24.

In particular, suppose that B₁ and B⁴⁰ ₁ are two different B-connections of g₁ (with associated return tuples rt₁ and rt⁴⁰ ₁, respectively), and that B₂ and B′₂ are two different B-connections of g₂ (with associated return tuples rt₂ and rt′₂, respectively). In addition, suppose that the recursive calls on PairProduct produce

[D,pt]=PairProduct(B₁, B₂) and [D′,pt′]=PairProduct(B′₁,B′₂).

Let rt and rt′ be the return tuples that the outer call on PairProduct creates for D and D′ in lines [23]-[35] of FIG. 24:pt, rt₁, and rt₂ are used to create rt; pt′₁, and rt′₂ are used to create rt′.

The question that we need to answer is whether it is ever possible for both D=D′ and rt=rt′ to hold. This is of concern because it would violate Structural Invariant 4; if this were to happen, then the first entry of the pair returned by PairProduct would not be a well-formed proto-CFLOBDD. The following proposition shows that, in fact, this cannot ever happen:

Proposition 3 The first entry of the pair returned by PairProduct is always a well-formed proto-CFLOBDD.

Proof: We argue by induction:

Base case: When g₁ and g₂ axe level-0 groupings, there are four cases to consider. In each case, it is immediate from lines [2]-[7] of FIG. 24 that the first entry of the pair returned by PairProduct is a well-formed proto-CFLOBDD.

Induction step: The induction hypothesis is that the first entry of the pair returned by PairProduct is a well-formed proto-CFLOBDD whenever the arguments to PairProduct are level-k proto-CFLOBDDs.

Let g₁ and g₂ be two arbitrary well-formed level k+1 proto-CFLOBDDs. We argue by contradiction: Suppose, for the sake of argument, that D, D′, rt, and rt′ are as defined above, and that both D=D′ and rt=rt′ hold.

By the inductive hypothesis, we know that D and D′ are each well-formed proto-CFLOBDDs. In particular, we can think of D and rt as corresponding to a decision tree T₀, labeled with the exit vertices of g that the decision tree's leaves are mapped to. However, because of the search that is carried out in lines [23]-[35] of PairProduct (FIG. 24), each exit vertex of g corresponds to a unique pair, (c₁, c₂), where c₁ and c₂ are exit vertices of g1 and g2, respectively. Thus, a leaf in T₀ can be thought of as being labeled with a pair (c₁, C₂).

Furthermore, because D=D′ and rt=rt′, D′ and rt′ also correspond to decision tree T₀.

When T₀ is considered to be the decision tree associated with D and rt, we can read off the decision trees that correspond to B₁ with exit vertices of g₁ labeling the leaves (call this T₁), and B₂ with exit vertices of g₂ labeling the leaves (T₂). Similarly, when T₀ is considered to be the decision tree associated with D′ and rt′, we can read off the decision trees that correspond to B′₁ with exit vertices of g₁ labeling the leaves (T′₁), and B′₂ with exit vertices of g₂ labeling the leaves (T′₂). (We use the first entry of each (c₁, c₂) pair for B₁ and B′₁, and the second entry of each (c₁, c₂) pair for B₂ and B′₂.) This gives us four trees, T₁, T′₁, T₂, and T₂, where T₁=T′₁, T₂=T′₂.

By assumption, g₁ and g₂ are well-formed proto-CFLOBDDs; thus, by Structural Invariant 2, all return tuples for the B-connections of g₁ and g₂ must represent 1-to-1 maps. Moreover, B₁, B₂, B′₁, and T′₂. are also well-formed proto-CFLOBDDs, which means that, in g₁, B₁ together with rt₁ must be the unique representative of T₁, while B′₁ together with rt′₁ must also be the unique representative of T′₁.

Similarly, in g₂, B₂ together with rt₂ must be the unique representative of T₂, while B′₂ together with rt′₂ must also be the unique representative of T′₂.

Therefore, in g₁, we have

−B=B′₁ and rt₁=rt′₁,

while in g₂, we have

−B₂=B′₂ and rt₂=rt′₂.

However, both of these conclusions contradict Structural Invariant 4, which, in turn, contradicts the assumption that g₁ and g₂ are well-formed level k+1 proto-CFLOBDDs. Consequently, the assumption that D=D′ and rt=rt′ cannot be true.

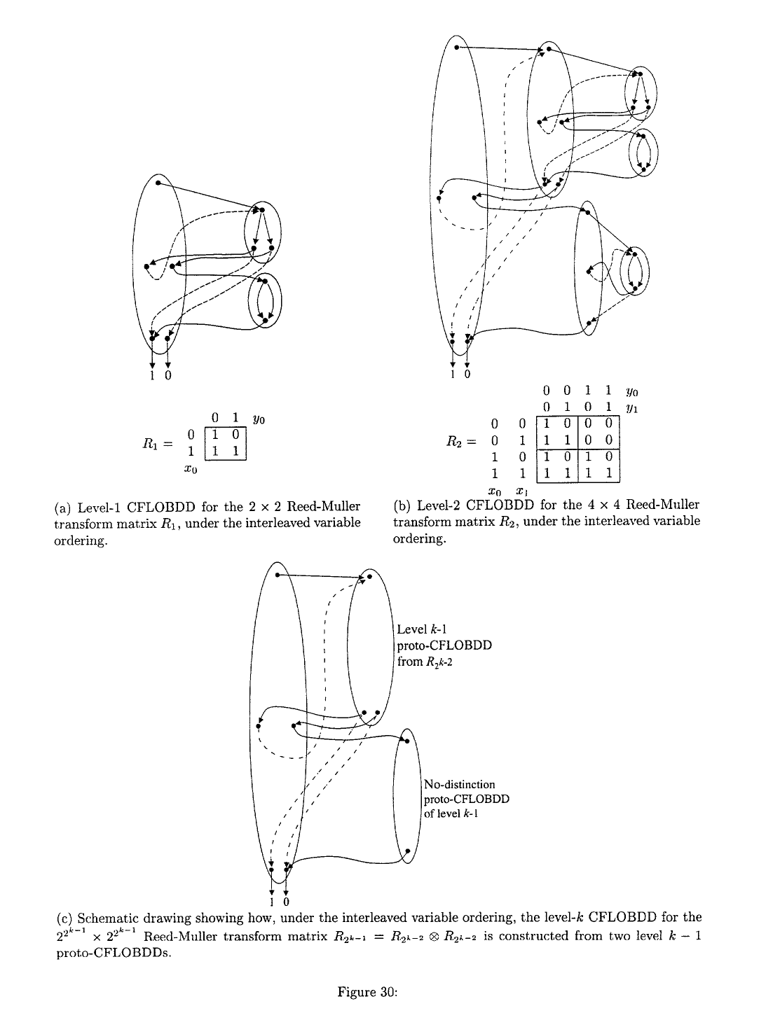

In the case of Boolean-valued CFLOBDDs, there are 16 possible binary operations, corresponding to the 16 possible two-argument truth tables (2×2 matrices with Boolean entries). (See column 1 of the table given in FIG. 28.) All 16 possible binary operations are special cases of BinaryApplyAndReduce; these can be performed by passing BinaryApplyAndReduce an appropriate value for argument op (i.e., some 2 ×2 Boolean matrix).

TERNARY OPERATIONS ON MULTI-TERMINAL CFLOBDDS

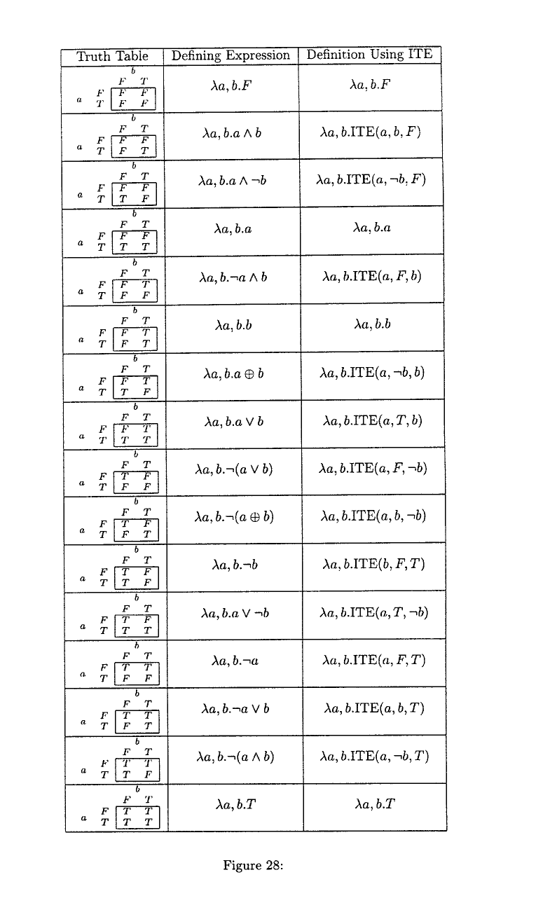

This section discusses how to perform ternary operations (i.e., three-argument operations) on multi-terminal CFLOBDDs. FIGS. 26 and 27 present the two new algorithms needed to implement ternary operations on multi-terminal CFLOBDDs. As in the previous section on “Binary Operations on Multi-Terminal CFLOBDDS”, we assume that the CFLOBDD or Grouping arguments of the operations described below are objects whose highest-level groupings are all at the same level.

The operation TernaryApplyAndReduce given in FIG. 26 is very much like the operation BinaryApplyAndReduce of FIG. 23, except that it starts with a call on TripleProduct instead of PairProduct. (See lines [3]-[4].)

The operation TripleProduct, which is given in FIG. 27, is very much like the operation PairProduct of FIG. 24, except that TripleProduct has a third Grouping argument, and performs a three-way—rather than two-way—cross product of the three Grouping arguments: g1, g2, and g3. TripleProduct returns the proto-CFLOBDD g formed in this way, as well as a descriptor of the exit vertices of g in terms of triples of exit vertices of the highest-level groupings of g1, g2, and g3.

(By an argument similar to the one given for PairProduct, it is possible to show that the grouping g constructed during a call on TripleProduct is always a well-formed proto-CFLOBDD—and hence it is permissible to call RepresentativeGrouping(g) in line [54] of FIG. 27.)

TernaryApplyAndReduce then uses the triples describing the exit vertices to determine the tuple of leaf values that should be associated with the exit vertices (i.e., a tentative value tuple). (See lines [5]-[7].)

Finally, TernaryApplyAndReduce proceeds in the same manner as BinaryApplyAndReduce:

Two tuples that describe the collapsing of duplicate leaf values—assuming folding to the left—are created via a call to CollapseClassesLeftmost. (See lines [8]-[10].)

The corresponding reduction is performed on Grouping g, by calling Reduce to fold g's exit vertices with respect to variable inducedReductionTuple (one of the tuples returned by the call on CollapseClassesLeftmost). (See lines [11]-[13].)

In the case of Boolean-valued CFLOBDDs, there are 256 possible ternary operations, corresponding to the 256 possible three-argument truth tables (2 ×2 ×2 matrices with Boolean entries). All 256 possible ternary operations are special cases of TernaryApplyAndReduce; these can be performed by passing TernaryApplyAndReduce an appropriate value for argument op (i.e., some 2 ×2 ×2 Boolean matrix.

One of the 256 ternary operations is the operation called ITE [BRB90] (for “If-Then-Else”), which is defined as follows:

ITE(a, b, c)=(a [symbol] b)V( [symbol] a [symbol] c).

FIG. 28 shows how the ternary ITE operation can be used to implement all 16 of the binary operations on Boolean-valued CFLOBDDs [BRB90].

REPRESENTING SPECTRAL TRANSFORMS WITH MULTI-TERMINAL CFLOBDDS

This section describes how multi-terminal CFLOBDDs can be used to encode families of integer matrices that capture some of the recursively defined spectral transforms, in particular, the Reed-Muller transform, the inverse Reed-Muller transform, the Walsh transform, and the Boolean Haar Wavelet transform [HMM85].

In each case, we will show how to encode a family of matrices M, where the n^{th} member of the family, Mₙ, for n≧1, is of size 2²^{ⁿ⁻¹}×2²^{ⁿ⁻¹}. (Transform matrices of other sizes can be represented by embedding them within a larger matrix whose dimensions are of the form 2²^{ⁱ⁻¹}×2²^{ⁱ⁻¹}.)

These encodings yield doubly exponential reductions in the size of the matrices. As will be shown below, each grouping that occurs in each of the CFLOBDD families is of size O(1); consequently, the level-k member of each family is of size O(k), whereas the corresponding matrix has 2²^{^{k}} entries.

REPRESENTING MATRICES AND KRONECKER PRODUCTS

The families of transform matrices that are to be encoded can be specified consisely in terms of an operation called the Kronecker product of two matrices, which is defined as follows:

$$\begin{matrix}A ⊗ B = [ \begin{matrix}{a}_{1.1} & ⋯ & {a}_{1 , m} \\ ⋮ & ⋰ & ⋮ \\ {a}_{n , 1} & ⋯ & {a}_{n , m}\end{matrix} ] ⊗ B \\ = [ \begin{matrix}{a}_{1.1} B & ⋯ & {a}_{1 , m} B \\ ⋮ & ⋰ & ⋮ \\ {a}_{n , 1} B & ⋯ & {a}_{n , m} B\end{matrix} ]\end{matrix}$$

Thus, if B is an array of size n′×m′, A\mathring{X}B is an array of size nn′×mm′. It is easy to see that the Kronecker product is associative, i.e.,

(A\mathring{X}B)\mathring{X}C=A\mathring{X}(B\mathring{X}C).

For matrices that represent spectral transforms, the left-hand argument A of a Kronecker product A\mathring{X}B often has a special form: typically, either A's elements are drawn from {0, 1}, or from {−1, 0, 1}.

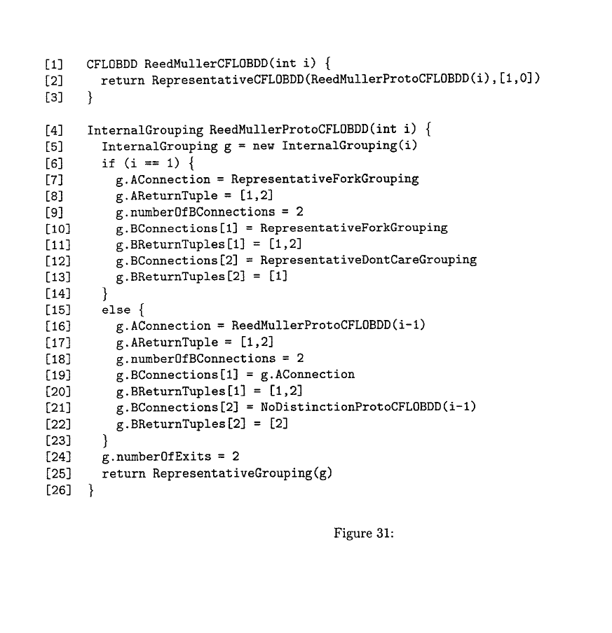

When using CFLOBDDs to represent the result of an application of a Kronecker product, it is especially convenient to use the interleaved variable ordering. The reason for this is illustrated in FIG. 29(a), which shows a level-k CFLOBDD for some (unspecified) array A, where A's elements are drawn from {0, 1}; FIG. 29(b) shows a level-k CFLOBDD for some (unspecified) array B (whose elements are drawn from {v₀, v₁, v₂, v₃}. (A and B could have been embedded into level k+1 CFLOBDDs; for the sake of clarity, we have not depicted such structures.) FIG. 29(c) shows the level k+1 CFLOBDD that represents the array that results from the Kronecker product A\hat{X}B. (In FIG. 29(c), we assume that none of the vᵢ, 0≦i≦3, are 0. If vᵢ=0, for some 0≦i≦3, then in the level k+1 grouping, the exit vertices with pointing to 0 and vᵢ would have been combined into a single exit vertex.)

Under the interleaved variable ordering, as we work through the CFLOBDD shown in FIG. 29(c) for a given assignment, the values of the first 2^{k} Boolean variables lead us to a middle vertex of the level k+1 grouping. This path will be continued according to the values of the next 2^{k} variables. Call these two paths p_{A} and p_{B}, respectively. Under the interleaved variable ordering, p_{A} takes us to a particular block of the matrix that FIG. 29(c) represents, and p_{B} takes us to a particular element of that block.

However, path p_{A} can also be thought of as taking us to an element e in matrix A. If the value of e is 0, then in the structure shown in FIG. 29(c) we must be at the first of the two middle vertices of the level k+1 grouping; if the value of e is 1, then we must be at the second of the two middle vertices. This allows us to give the following interpretation of FIG. 29(c):

In the CFLOBDD shown in FIG. 29(c), the first of the two middle vertices is connected to a no-distinction proto-CFLOBDD, and hence no matter what the values of the second group of 2^{k} variables are, path p_{B} must lead to the value 0. Thus, in the matrix that FIG. 29(c) represents, there is a block of all 0's in each position that corresponds to a 0 in A.

In the CFLOBDD shown in FIG. 29(c), the second of the two middle vertices is connected to the proto-CFLOBDD that is the core of the representation of matrix B, and thus path p_{B} must proceed to exactly the same value as it does in the representation of B (cf. FIGS. 29(b) and 29(c)) Consequently, in the matrix that FIG. 29(c) represents, there is a block that is identical to B in each position that corresponds to a 1 in A.

In both cases, this is exactly what is required of the matrix A\mathring{X}B; hence, by the canonicity property, the multi-terminal CFLOBDD shown in FIG. 29(c) must be the unique representation of A\mathring{X}B under the interleaved variable ordering. In the case where A and B are matrices whose values are drawn from {w₀, . . . , wₘ} and {v₀, . . . , vₙ}, respectively, essentially the same construction can be used, except that a call on Reduce may also need to be applied. (Without loss of generality, we will assume that the sequences of exit vertices in the CFLOBDDs of A and B are mapped to the sequences of values [w₀, . . . ,wₘ] and [v₀, . . . ,Vₙ], respectively.) The steps required are as follows:

Create a level k+1 grouping that has m+1 middle vertices, corresponding to the values [w₀, . . . , Wₘ], and (m+1) (n+1) exit vertices, corresponding to the values

[wᵢwⱼ:i [symbol] [0..m], j [symbol] [0..n]].

For each middle vertex, which corresponds to some value wᵢ, for 0≦i≦m, create a B-connection to the proto-CFLOBDD of B, and a return tuple from the exit vertices of the proto-CFLOBDD of B to the exit vertices of the level k+1 grouping that correspond to the values [wᵢc₀, . . . , wᵢvₙ].

If any of the values in the sequence

[wᵢvⱼ:i [symbol] [0..m,] j [symbol] [0..n]]

are duplicates, make an appropriate call on Reduce to fold together the classes of exit vertices that are associated with the same value, thereby creating a multi-terminal CFLOBDD.

By exactly the same argument given above for the case where A is a {0, 1}-matrix, the resulting multi-terminal CFLOBDD must be the unique representation of the matrix A\mathring{X}B under the interleaved variable ordering.

REPRESENTING THE REED-MULLER TRANSFORM

The family of matrices for the Reed-Muller transform, denoted by Rₙ, can be defined recursively, as follows [CFZ95b]:

$${R}_{0} = [ 1 ] {R}_{n} = [ \begin{matrix}{R}_{n - 1} & 0 \\ {R}_{n - 1} & R - n - 1\end{matrix} ]$$

where [1] denotes the 1 ×1 matrix whose single entry is the value 1. In terms of the Kronecker product, this family of matrices can be specified as follows:

$${R}_{0} = [ 1 ] {R}_{n} = [ \begin{matrix}1 & 0 \\ 1 & 1\end{matrix} ] ⊗ {R}_{n - 1}$$

An immediate consequence of this definition is that

$${R}_{n} = {\underbrace{\begin{matrix}[ \begin{matrix}1 & 0 \\ 1 & 1\end{matrix} ] & ⊗ … ⊗ [ \begin{matrix}1 & 0 \\ 1 & 1\end{matrix} ]\end{matrix}}}_{n times}$$

from which it follows that

R₂ᵢ=Rᵢ\mathring{X}Rᵢ.

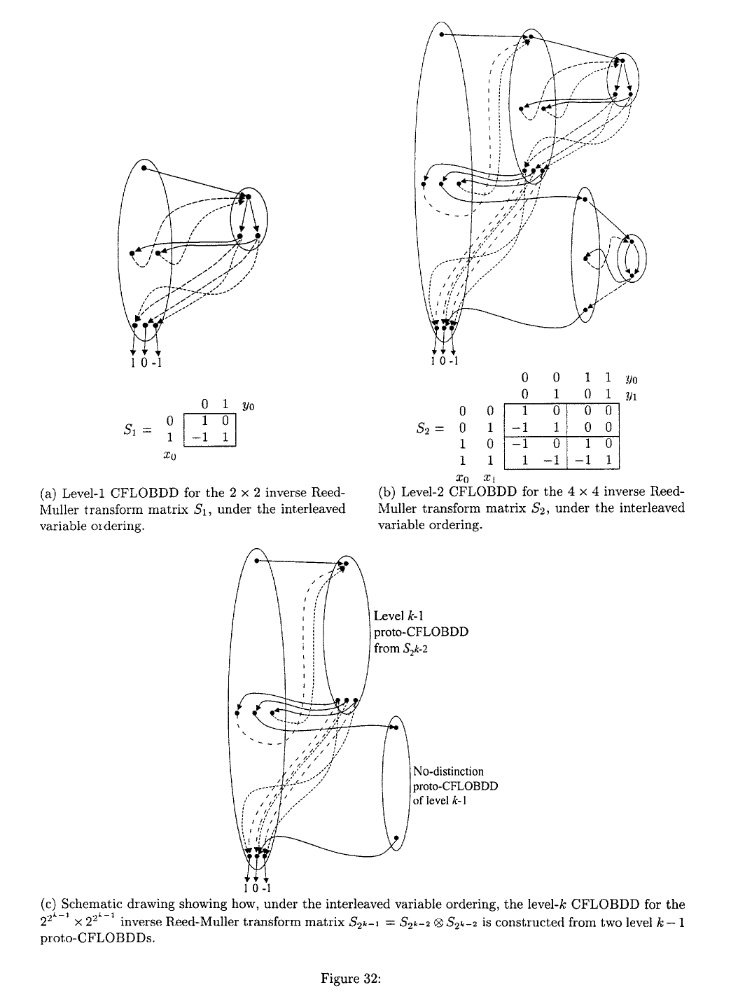

FIGS. 30(a) and 30(b) show the first two CFLOBDDs in the family of CFLOBDDs that represent the Reed-Muller transform matrices of the form R_{2′}. FIG. 30(c) shows the general pattern for constructing a level-k CFLOBDD for the Reed-Muller transform matrix R₂_{^{k-1}}, which is of size 2²^{^{k-1}}×2²^{^{k-1}}. Pseudo-code for the construction of these objects is given in FIG. 31.

It is instructive to compare FIG. 30(c) with FIG. 29(c). FIG. 30(c) is a particular instance of FIG. 29(c), where in FIG. 30(c) the proto-CFLOBDD labeled “Level k-1 proto-CFLOBDD from R₂_{^{k-2}}” plays the role of both of the proto-CFLOBDDs A and B depicted in FIG. 29(c). This shows quite clearly how the construction reflects the property

R₂ᵢ=Rᵢ\mathring{X}R_{i;}.

in particular,

$$\begin{matrix}{R}_{{2}^{k - 1}} = {R}_{2 \times {2}^{k - 2}} \\ = {R}_{{2}^{k - 2}} ⊗ {R}_{{2}^{k - 2.}}\end{matrix}$$

One difference between FIGS. 30(c) and 29(c) is that in the highest-level grouping, the order of the values 0 and 1 is reversed; in FIG. 30(c), the values have the order [1, 0], whereas in FIG. 29(c) the order is [0, 1]. This is a consequence of the fact that the element in the upper-left-hand corner of a Reed-Muller transform matrix is always a 1; under the interleaved variable ordering, this element corresponds the leftmost element of the decision tree for the matrix.

REPRESENTING THE INVERSE REED-MULLER TRANSFORM

The family of matrices for the inverse Reed-Muller transform, denoted by Sₙ, can be defined recursively, as follows [CFZ95b]:

$${S}_{0} = [ 1 ] {S}_{n} = [ \begin{matrix}{S}_{n - 1} & 0 \\ - {S}_{n - 1} & {S}_{n - 1}\end{matrix} ]$$

In terms of the Kronecker product, this family of matrices can be specified as follows:

$${S}_{0} = [ 1 ] {S}_{n} = [ \begin{matrix}1 & 0 \\ - 1 & 0\end{matrix} ] ⊗ {S}_{n - 1}$$

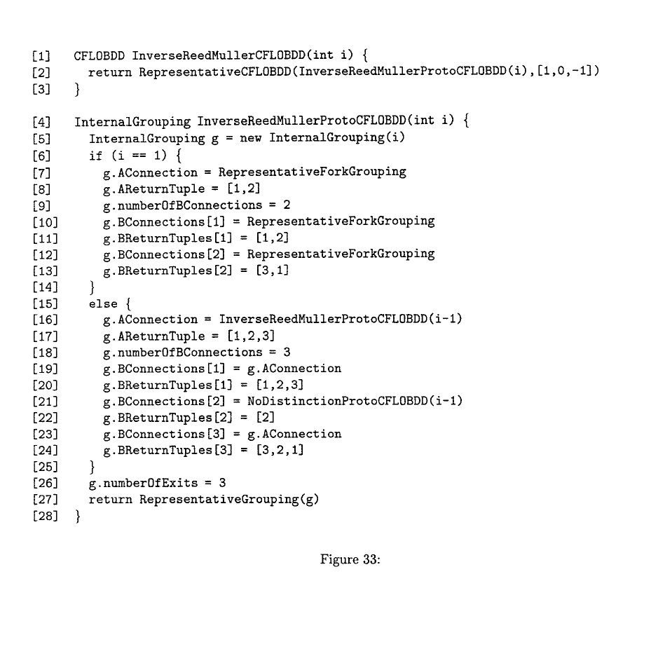

FIGS. 32(a) and 32(b) show the first two CFLOBDDs in the family of CFLOBDDs that represent the inverse Reed-Muller transform matrices of the form S₂_{ⁱ}. In particular, FIG. 32(c) shows the general pattern for constructing a level-k CFLOBDD for the inverse Reed-Muller transform matrix S₂_{^{k-1}}, which is of size 2²^{^{k-1}}×2²^{^{k-1}}. Pseudo-code for the construction of these objects is given in FIG. 33.

REPRESENTING THE WALSH TRANSFORM

The family of matrices for the Walsh transform, denoted by W_{N}, can be defined recursively, as follows [CMZ⁺93, CFZ95a]:

$${W}_{0} = [ 1 ] {W}_{n} = [ \begin{matrix}{W}_{n - 1} & {W}_{n - 1} \\ {W}_{n - 1} & - {W}_{n - 1}\end{matrix} ]$$

In terms of the Kronecker product, this family of matrices can be specified as follows:

$${W}_{0} = [ 1 ] {W}_{n} = [ \begin{matrix}1 & 1 \\ 1 & - 1\end{matrix} ] ⊗ {W}_{n - 1}$$

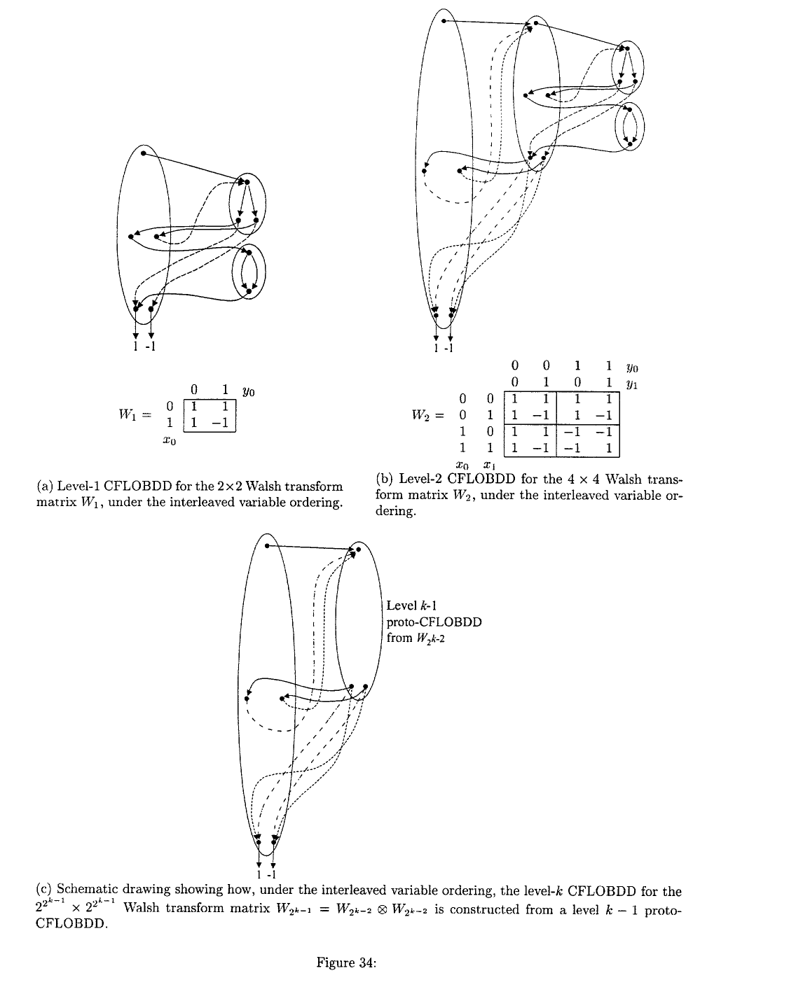

FIGS. 34(a) and 34(b) show the first two CFLOBDDs in the family of CFLOBDDs that represent the Walsh transform matrices of the form W₂_{ⁱ}. In particular, FIG. 34(c) shows the general pattern for constructing a level-k CFLOBDD for the Walsh transform matrix W₂_{^{k-1}}, which is of size 2²^{^{k-1}}×2²^{^{k-1}}. Pseudo-code for the construction of these objects is given in FIG. 35.

REPRESENTING OTHER TRANSFORM MATRICES

In the context of devising generalized BDD-like representations, Clarke, Fujita, and Zhao [CFZ95b] have studied the transformation matrices produced by performing Kronecker products of various different non-singular 2 ×2 matrices M to define a family of transform matrices, say Tₙ, in a fashion similar to the Reed-Muller, inverse Reed-Muller, and Walsh transform matrices:

T₀=[1] Tₙ=M\mathring{X}Tₙ₋₁.

They state that if the entries of M are restricted to {-1,0, I}, there are six interesting matrices:

$$[ \begin{matrix}1 & 0 \\ 0 & 1\end{matrix} ] [ \begin{matrix}1 & 0 \\ - 1 & 1\end{matrix} ] [ \begin{matrix}1 & 0 \\ 1 & 1\end{matrix} ] \\ [ \begin{matrix}0 & 1 \\ - 1 & 1\end{matrix} ] [ \begin{matrix}0 & 1 \\ 1 & 1\end{matrix} ] [ \begin{matrix}1 & 1 \\ - 1 & 1\end{matrix} ]$$

The second and third of these define the inverse Reed-Muller transform, and the Reed-Muller transform, and lead to the families of CFLOBDDs illustrated in FIGS. 32 and 30, respectively.

The methods for constructing a family of CFLOBDDs that represent each of the other four families of transform matrices represent only small varations on the constructions that we have spelled out in detail above; a level-k CFLOBDD is used to encode transform matrix T₂_{^{k-1}}, which is of size 2²^{^{k-1}}×2²^{^{k-1}}; etc. Because no new principles are involved, further details are not given here.

REPRESENTING THE BOOLEAN HAAR WAVELET TRANSFORM

Hansen and Sekine give a recursive definition for a matrix that can be used to compute the Boolean Haar Wavelet transform [HS97] in the following way: First, they define D₀ to be [1], and the matrices Dₙ, for n≧1. to be the matrices of size 2ⁿ×2ⁿ in which the first row is all ones, and all other elements are zero; that is,

$${D}_{0} = [ 1 ] {D}_{n} = [ \begin{matrix}1 & 1 \\ 0 & 0\end{matrix} ] ⊗ {D}_{n - 1} .$$

The Boolean Haar Wavelet transform matrix defined by Hansen and Sekine, which we will denote by H′ₙ, is then defined as

Hₙ=Aₙ+Dₙ,

where Aₙ is defined recursively, as follows:

$$\begin{matrix}{A}_{0} = [ 0 ] \\ {A}_{n} = [ \begin{matrix}1 & 0 \\ 0 & 1\end{matrix} ] ⊗ {A}_{n - 1} + [ \begin{matrix}0 & 0 \\ 1 & - 1\end{matrix} ] ⊗ {D}_{n - 1} .\end{matrix} \qquad ( 2 )$$

For instance, when n=3, this defines the matrix

$${H}_{3}^{′} = [ \begin{matrix}1 & 1 & 1 & 1 & 1 & 1 & 1 & 1 \\ 1 & - 1 & 0 & 0 & 0 & 0 & 0 & 0 \\ 1 & 1 & - 1 & - 1 & 0 & 0 & 0 & 0 \\ 0 & 0 & 1 & - 1 & 0 & 0 & 0 & 0 \\ 1 & 1 & 1 & 1 & - 1 & - 1 & - 1 & - 1 \\ 0 & 0 & 0 & 0 & 1 & - 1 & 0 & 0 \\ 0 & 0 & 0 & 0 & 1 & 1 & - 1 & - 1 \\ 0 & 0 & 0 & 0 & 0 & 0 & 1 & - 1\end{matrix} ]$$

Equation (2) can be used as the basis for an algorithm—based on the Kronecker product and addition—to create CFLOBDDs that encode this version of the Boolean Haar Wavelet transform matrix; however, the method for constructing this family of CFLOBDDs directly is rather awkward to state.

Fortunately, we can define a different family of matrices that captures the Boolean Haar Wavelet transform form (in the sense that the rows of the matrices in the new family are permutations of the rows of the matrices defined by Equation (2)). The new definition leads to a straightforward method for constructing the CFLOBDD encodings. First, we define E₀ to be [1], and the matrices Eₙ, for n≧1, to be the matrices of size 2ⁿ×2ⁿ in which the last row is all ones, and all other elements are zero; that is,

$${E}_{0} = [ 1 ] {E}_{n} = [ \begin{matrix}0 & 0 \\ 1 & 1\end{matrix} ] ⊗ {E}_{n - 1} .$$

The new version of the Boolean Haar Wavelet transform matrix, denoted by Hₙ, is defined recursively, as follows:

$$\begin{matrix}{H}_{0} = [ 1 ] \\ {H}_{n} = [ \begin{matrix}1 & 0 \\ 0 & 1\end{matrix} ] ⊗ {H}_{n - 1} + [ \begin{matrix}0 & - 1 \\ 1 & 0\end{matrix} ] ⊗ {E}_{n - 1} .\end{matrix} \qquad ( 3 )$$

This can also be expressed as

$$\begin{matrix}{H}_{0} = [ 1 ] \\ {H}_{n} = [ \begin{matrix}{H}_{n - 1} & - {E}_{n - 1} \\ {E}_{n - 1} & {H}_{n - 1}\end{matrix} ]\end{matrix} \qquad ( 4 )$$

For n=3, this definition yields the following matrix:

$${H}_{3} = [ \begin{matrix}0 & - 1 & 0 & 0 & 0 & 0 & 0 & 0 \\ 1 & 1 & - 1 & - 1 & 0 & 0 & 0 & 0 \\ 0 & 0 & 1 & - 1 & 0 & 0 & 0 & 0 \\ 1 & 1 & 1 & 1 & - 1 & - 1 & - 1 & - 1 \\ 0 & 0 & 0 & 0 & 1 & - 1 & 0 & 0 \\ 0 & 0 & 0 & 0 & 1 & 1 & - 1 & - 1 \\ 0 & 0 & 0 & 0 & 0 & 0 & 1 & - 1 \\ 1 & 1 & 1 & 1 & 1 & 1 & 1 & 1\end{matrix} ]$$

The only difference between H₃ and H′₃ is that the first row of H′₃, the row of all 1's, appears as the last row of H₃. Note, however, that this gives H₃ a nice property that is not possessed by H′₃:

All of the non-zero elements in the (strict) upper triangle are −1.

All of the non-zero elements in the (strict) lower triangle are 1.

All of the diagonal elements are 1.

This property is possessed by all of the matrices in the family Hₙ, for n≧1.

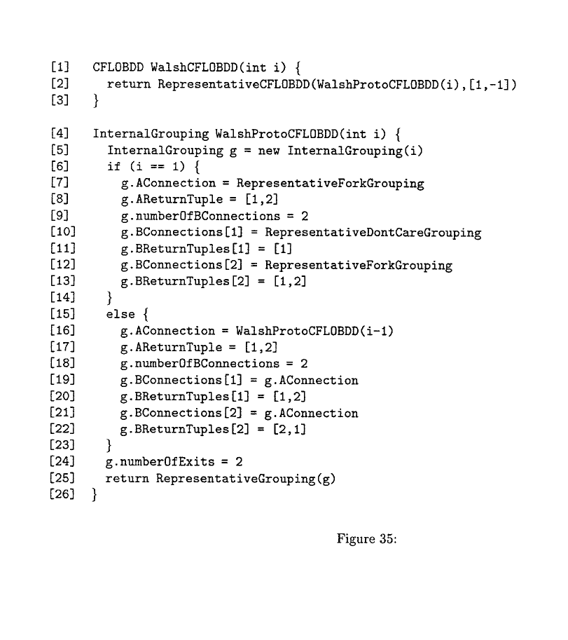

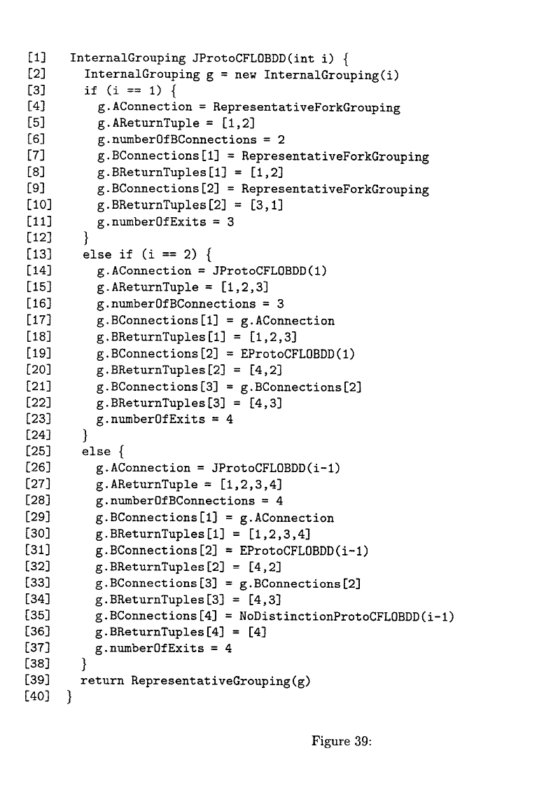

FIGS. 36, 38, and 40 illustrate the structure of the objects involved in encoding the Boolean Haar Wavelet transform matrices of the form H₂. In particular, FIG. 40(c) shows the general pattern for constructing a level-k CFLOBDD for the Boolean Haar Wavelet transform matrix H₂_{^{k-1}}, which is of size 2²^{^{k-1}}×2²^{^{k-1}}.

The principles behind FIGS. 36, 38, and 40 are as follows:

FIG. 36(a) and 36(b) show the first two CFLOBDDs in the family of CFLOBDDs that represent the E matrices of the form E₂_{ⁱ}. FIG. 36(c) shows the general pattern for constructing a level-k CFLOBDD for the matrix E₂_{^{k-l}}. The structure of the CFLOBDDs shown FIG. 36 is similar to those that appear in FIGS. 30, 32, and 34.

In FIG. 36(c), the purpose of the proto-CFLOBDD labeled “Level k-1 proto-CFLOBDD from E₂_{^{k-2}}” is to isolate the entries of the last-row of the last-row of the . . . last-row, which are then associated with the value 1. All other entries are associated with the value 0.

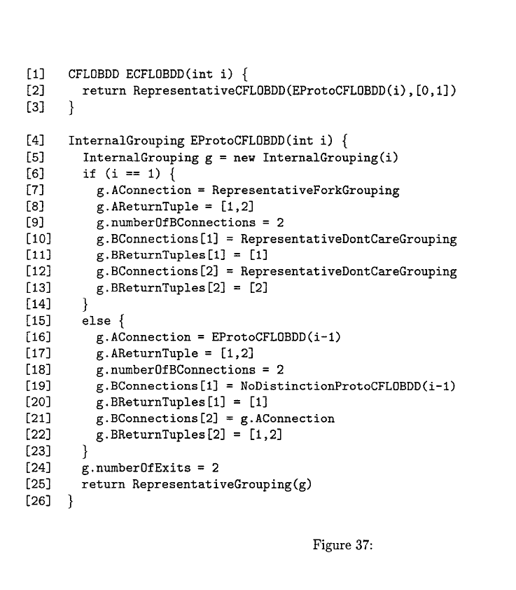

FIG. 38 introduces a set of auxiliary proto-CFLOBDDs that occur in the encoding of the Boolean Haar Wavelet transform matrices. The purpose of these components is to separate sub-blocks of the matrix into four categories; accordingly, exit vertices and middle vertices in FIGS. 38(a), 38(b), and 38(c) have been labeled with H, E, −E, and 0 as an aid to identifying the roles that these vertices play in separating matrix sub-blocks into the four groups:

Vertices labeled with H correspond to sub-blocks that are on the diagonal of the matrix; matched paths through these vertices eventually feed into J proto-CFLOBDDs (or, as we shall see in FIG. 40, into H proto-CFLOBDDs), which further separate the on-diagonal sub-blocks into smaller sub-blocks.

Vertices labeled with E and −E correspond to sub-blocks that are off the diagonal of the matrix: vertices labeled E correspond to sub-blocks in the matrix's strict lower triangle; vertices labeled −E correspond to sub-blocks in the matrix's strict upper triangle. Matched paths through both E and −E vertices eventually feed into proto-CFLOBDDs from the E family, which further separate the off-diagonal sub-blocks into smaller sub-blocks. For an A-connection or B-connection emanating from an E vertex, the corresponding return edge leads back to an E vertex (corresponding to the fact that we are still dealing with a sub-block in the matrix's strict lower triangle); for an A-connection or B-connection emanating from a −E vertex, the corresponding return edge leads back to a −E vertex (corresponding to the fact that we are still dealing with a sub-block in the matrix's strict upper triangle).

FIG. 40(a) and 40(b) show the first two CFLOBDDs in the family of CFLOBDDs that represent the Boolean Haar Wavelet transform matrices of the form H₂_{ⁱ}. FIG. 40(c) shows the general pattern for constructing a level-k CFLOBDD for the matrix H₂_{^{k-1}}. Again, as an aid to identifying the roles that various vertices play in separating matrix sub-blocks, middle vertices of the groupings in the H family in FIGS. 38(b) and 38(c) have been labeled with H, E, −E, and 0.

In contrast to groupings of the J family, which for levels 2 and higher all have four exit vertices, groupings of the H family at levels 2 and higher all have three exit vertices. From left to right, these correspond to matrix elements with the values 1,−1, and 0, respectively. In particular, the leftmost exit vertex corresponds not only to the diagonal elements (all of which have the value 1), but also to all of the non-zero elements in the matrix's strict lower triangle.

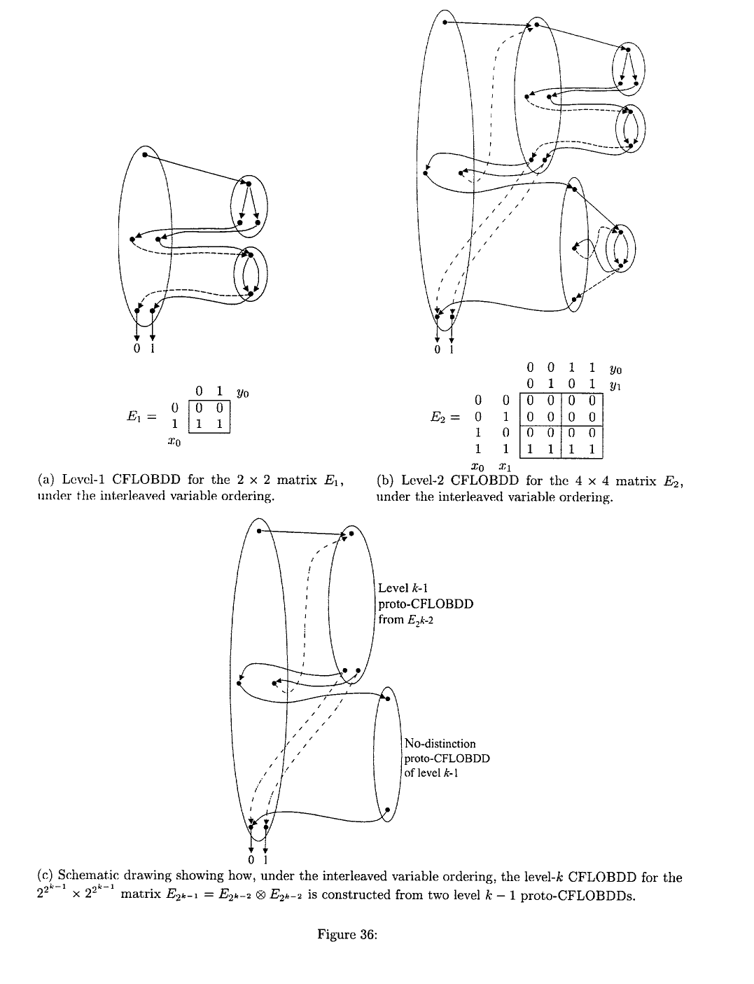

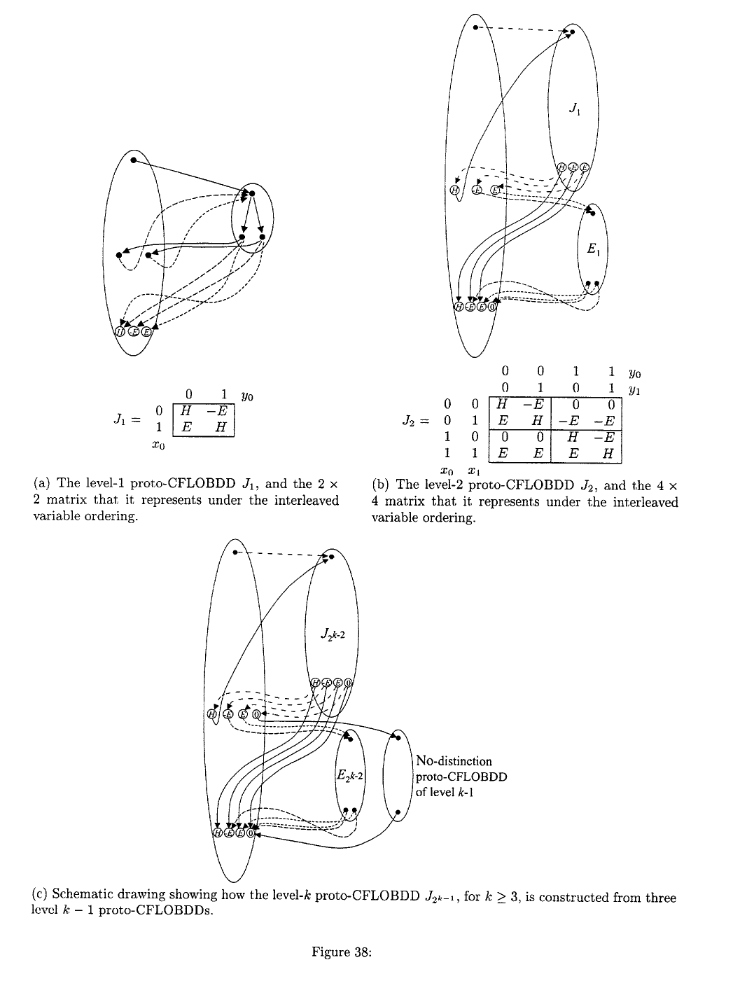

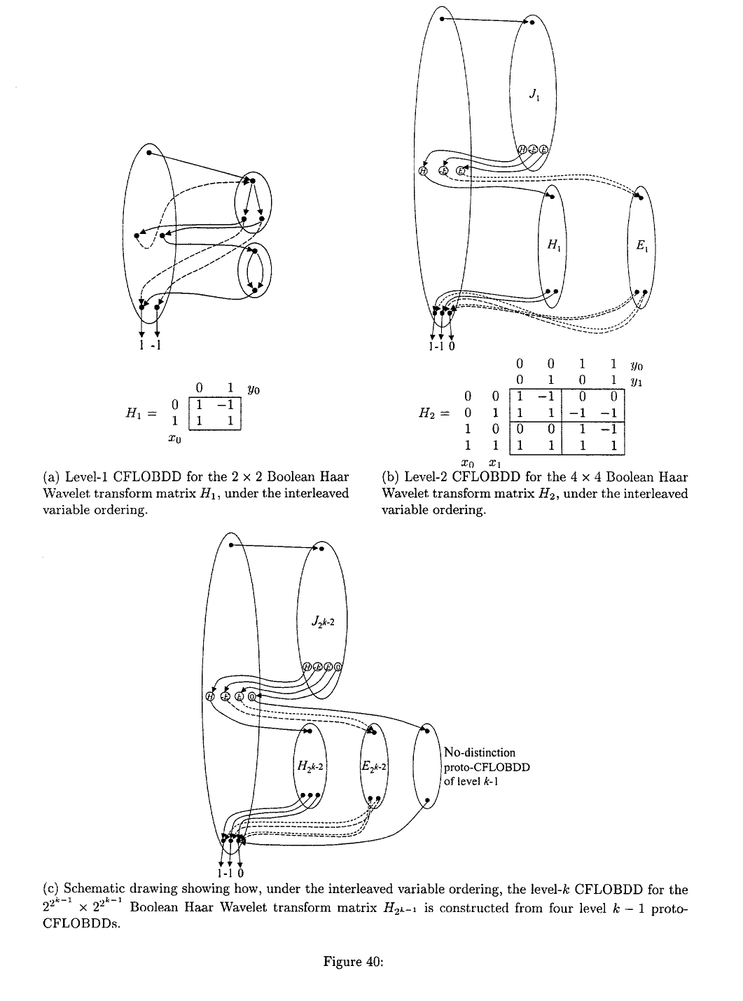

Pseudo-code for the construction of the objects involved in encoding the Boolean Haar Wavelet transform matrices of the form H₂_{ⁱ}, is given in FIGS. 37, 39, and 41, respectively.

DATA COMPRESSION USING MULTI-TERMINAL CFLOBDDS

Earlier, Algorithm 1 spelled out a way for a decision tree to be converted into a multi-terminal CFLOBDD. In particular, Algorithm 1 is a recursive procedure that constructs a level-k CFLOBDD from an arbitrary decision tree that is of height 2^{k} (and has 2²^{^{k}} leaves).

This method provides a mechanism for using CFLOBDDs for the purpose of data compression (and subsequent storage and/or transmission of the data in compressed form):

The signal to be compressed consists of a sequence of values drawn from some finite value space. The sequence is considered to be the values that label, in left-to-right order, the leaves of a decision tree. If the length of the signal is s, the decision tree used is one whose height is 2^{k}, where k is the smallest value for which s ≦2²^{^{k}}; the extra leaves are labeled with a distiniguished value that indicates that they are not part of the signal. Algorithm 1 is then applied to the decision tree to create a CFLOBDD C.

For purposes of transmission of compressed data, well-known techniques can be used to linearize the CFLOBDD C into a form that can be (i) transmitted across a communication channel, and (ii) converted back into an in-memory linked data structure so as to recover the CFLOBDD on the receiving end. (The linearization process involves no size blow-up; it generates a sequence of bits that represents the CFLOBDD, where the length of the sequence is linear in the size of the CFLOBDD.)

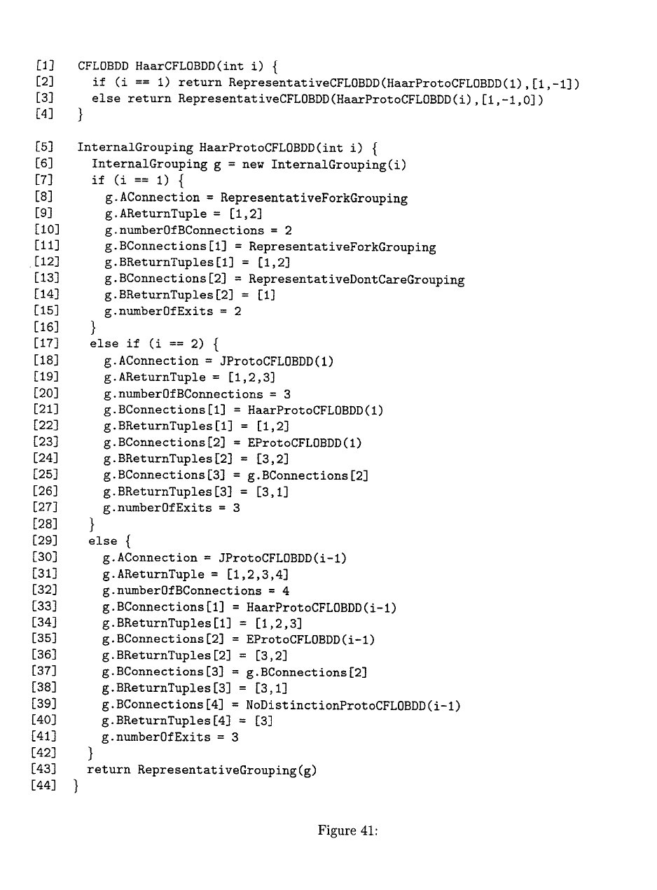

Of course, it is useless to be able to compress data without a method for recovering the original signal from the compressed data. An algorithm for uncompressing CFLOBDDs is presented in FIG. 42. In particular, function UncompressCFLOBDD of FIG. 42 uncompresses a multi-terminal CFLOBDD to create the sequence of values that would label, in left-to-right order, the leaves of the CFLOBDD's corresponding decision tree.

In UncompressCFLOBDD, the sequence-valued variable S is used as a stack that controls a (non-recursive) traversal of CFLOBDD C—mimicking the traveral that would be carried out when interpreting some Boolean-variable-to-Boolean-value assignment. The elements of traversal stack S are instances of class TraverseState, and record which Grouping of C is being visited, as well as VisitState information, which indicates whether the visit is the one before the visit to the A-connection (FirstVisit), after the visit to the A-connection but before the visit to the B-connection (SecondVisit), or after the visit to the B-connection (ThirdVisit).¹¹ (A fourth VisitState value, Restart, is used to mark the stack when a snapshot is taken—see lines [19] and [28] of FIG. 42.) ¹¹In the case of a TraverseState that holds ThirdVisit information, an additional index is recorded, which indicates which of the B-connections was visited.

Function UncompressCFLOBDD uses a backtracking method to process all possible assignments in lexicographic order. Because of the way that backtracking is carried out, UncompressCFLOBDD does not manipulate assignments explicitly; instead, the sequence-valued variable T is used as a stack that records snapshots of traversal-stack S. (That is, T is a sequence whose elements are themselves sequences of TraverseStates.) When UncompressCFLOBDD has finished processing one assignment and proceeds to the next one (line [14] of FIG. 42), the state of S is re-established by recovering the stored state from snapshot-stack T. In particular, this recovers the longest prefix that the next assignment to be processed shares with any previously processed one. UncompressCFLOBDD uses the next entry of T to pick up the traversal in the middle of C, which saves work that would otherwise be necessary to retraverse C in order to reach the same resumption point.

In FIG. 42, it is assumed that sequences are allowed to share common prefixes, and that manipulations of stacks S and T are carried out non-destructively. That is, an operation such as

[S,ts]=SplitOnLast(S)

sets S to the prefix of sequence S that consists of all but the last element of S; however, the value of any other variable that was holding onto the original value of S is unchanged by the statement “[S,ts]=SplitOnLast (S)”. It is easy to achieve this effect by implementing S and T using linked-list data structures.

RELATIONSHIP TO PRIOR ART

As stated earlier, a BDD is a data structure that—in the best case—yields an exponential reduction in the size of the representation of a function over Boolean-valued arguments (i.e., compared with the size of the decision tree for the function). In contrast, a CFLOBDD—again, in the best case—yields a doubly exponential reduction in the size of the representation of a function.

In the best case, an RBOBDD also yields a better-than-exponential compression in the size of the decision tree; however, the principle by which this extra compression is achieved is somewhat ad hoc, and its effect tends to dissipate as ROBDDs are combined to build up representations of more complicated functions. For instance, for the family of dot-product functions whose first two members are discussed in FIGS. 3 and 4, ROBDDs provide exponential compression, whereas CFLOBDDs provide doubly exponential compression.

A number of generalizations of OBDDs/ROBDDs have been proposed [SF96], including Multi-Terminal BDDs [CMZ⁺93, CFZ95a], Algebraic Decision Diagrams (ADDs) [BFG+931, Binary Moment Diagrams (BMDs) [BC95], Hybrid Decision Diagrams (HDDs) [CFZ95c, CFZ95b], and Differential BDDs [AMU95]. A number of these also achieve various kinds of exponential improvement over OBDDs on some examples.

CFLOBDDs are unlike these structures in that they are all based on acyclic graphs, whereas CFLOBDDs use cyclic graphs. The key innovation behind CFLOBDDs is the combination of cyclic graphs with the matched-path principle. The matched-path principle lets us give the correct interpretation of a certain class of cyclic graphs as representations of functions over Boolean-valued arguments. It also allows us to perform operations on functions represented as CFLOBDDs via algorithms that are not much more complicated than their BDD counterparts. Finally, the matched-path principle is also what allows a CFLOBDD to be, in the best case, exponentially smaller than the corresponding BDD.

There have been three other generalizations of OBDDs that make use of cyclic graphs: Indexed BDDs (IBDDs) [JBA⁺97], Linear/Exponentially Inductive Functions (LIFs/EIFs) [GF93, Gup94], and Cyclic BDDs (CBDDs) [Ref99]. The differences between CFLOBDDs and these representations can be characterized as follows:

The aforementioned representations all make use of numeric/arithmetic annotations on the edges of the graphs used to represent functions over Boolean arguments, rather than the matched-path principle that is basis of CFLOBDDs. The latter can be characterized in terms of a context-free language of matched parentheses, rather than in terms of numbers and arithmetic (see footnote 4).

An essential part of the design of LIFs and EIFs is that the BDD-like subgraphs in them are connected up in very restricted ways. In contrast, in CFLOBDDs, different groupings at the same level (or different levels) can have very different kinds of connections in them.

Similarly, CBDDs require that there be some fixed BDD pattern that is repeated over and over in the structure; a given function uses only a few such patterns. With CFLOBDDs, there can be many reused patterns (i.e., in the lower-level groupings in CFLOBDDs).

In CFLOBDDs, as in BDDs, each variable is interpreted exactly once along each matched path; IBDDs permit variables to be interpreted multiple times along a single path.

IBDDs and CBDDs are not canonical representations of Boolean functions, which complicates the algorithms for performing certain operations on them, such as the operation to determine whether two IBDDs (CBDDs, respectively) represent the same function.

The layering in CFLOBDDs serves a different purpose than the layering found in IBDDs, LIFs/EIFs, and CBDDs. In the latter representations, a connection from one layer to another serves as a jump from one BDD-like fragment to another BDD-like fragment; in CFLOBDDs, only the lowest layer (i.e., the collection of level-0 groupings) consists of BDD-like fragments (and just two very simple ones at that). It is only at level 0 that the values of variables are interpreted. As one follows a matched path through a CFLOBDD, the connections between the groupings at levels above level 0 serve to encode which variable is to be interpreted next.

IBDDs, LIFs/EIFs, and CBDDs could all be generalized by replacing the BDD-like subgraphs in them with CFLOBDDs.

Similarly, other variations on BDDs [SF96], such as EVBDDs [LS92], BMDs [BC95], *BMDs [BC95], HDDs [CFZ95c, CFZ95b], which are all based on DAGs, could be generalized to use cyclic data structures and matched paths, along the lines of CFLOBDDs.

While the foregoing specification of the invention has described it with reference to specific embodiments thereof, it will be apparent that various modifications and changes may be made thereof without departing from the broader spirit and scope of the invention. The specification and drawings are, accordingly, to be regarded in an illustrative rather than a restrictive sense.

REFERENCES

[AMU95] A. Anuchitanukul, Z. Manna. and T. E. Uribe. Differential BDDs. In J. van Leeuween, editor, Computer Science Today: Recent Trends and Developments, volume 1000 of Lecture Notes in Computer Science, pages 218-233. Springer-Verlag. 1995.

[BC95] R. E. Bryant and Y. -A. Chen. Verification of arithmetic circuits with binary moment diagrams. In Proc. of the 30th ACM/IEEE Design Automation Conf., pages 535-541, 1995.

[BFG+93] R. I. Bahar, E. A. Frohm, C. M. Gaona, G. D. Hachtel, E. Macii. A. Pardo, and F. Sonienzi. Algebraic decision diagrams and their applications. In Proc. of the Int. Conf. on Computer Aided Design, pages 188-191, November 1993.

[BRB90] K. S. Brace, R. L. Rudell, and R. E. Bryant. Efficient implementation of a BDD package. In P7oc. of the 27th ACM/IEEE Design Automation Conf., pages 40-45, 1990.

[Bry86] R. E. Bryant. Graph-based algorithms for Boolean function manipulation. IEEE Trans. on Computers, C-35(6):677-691, August 1986.

[Bry92] R. E. Bryant. Symbolic boolean manipulation with ordered binary-decision diagrams. ACM Computing Surveys, 24(3):293-318, September 1992.

[CE81] E. M. Clarke. Jr. and E. A. Emerson. Synthesis of synchronization skeletons for branching time temporal logic. In LNCS 131, Logic of Programs: Workshop: 1981.

[CFZ95a] E. M. Clarke, Jr., M. Fujita, and X. Zhao. Applications of multi-terminal binary decision diagrams.

Technical Report CS-95-160, Carnegie Mellon Univ., School of Comp. Sci., April 1995.

[CFZ95b] E. M. Clarke, Jr., M. Fujita, and X. Zhao. Hybrid decision diagrams:Overcoming the limitations of MITBDDs and BMDs. Technical Report CS-95-159, Carnegie Mellon Univ., School of Comp. Sci., April 1995.

[CFZ95c] E. M. Clarke, Jr., M. Fujita, and X. Zhao. Hybrid decision diagrams:Overcoming the limitations of MTBDDs and BMDs. In Proc. of the Int. Conf. on Computer Aided Design, pages 159-163, November 1995.

[CGP99] E. M. Clarke, Jr., 0. Grumberg, and D. A. Peled. Model Checking. The M.I.T. Press, 1999.

[CMZ⁺93] E. M. Clarke, Jr., K. McMillan, X. Zhao, M. Fujita, and J. Yang. Spectral transforms for large Boolean functions with applications to technology mapping. In Proc. of the 30th ACM/IEEE Design Automation Conf., pages 54-60, 1993.

[Dew79] R. B. K. Dewar. The SETL Programmmng Language. 1979. Available at “http://birch.eecs.lehigh.edu/˜bacon/setlprog.ps.gz”.

[GF93] A. Gupta and A. L. Fisher. Representation and symbolic manipulation of linearly inductive Boolean functions. In Proc. of the Int. Conf. on Computer Aided Design, pages 192 199, November 1993.

[Gup94] A. Gupta. Inductive Boolean Function Manipulation: A Hardware Verification Methodology for Automatic Induction. PhD thesis, School of Comp. Sci., Carnegie Mellon Univ., Pittsburgh, Pa., 1994.

[HMM85] S. L. Hurst, D. M. Miller, and J. C. Muzio. Spectral Techniques in Digital Logic. Academic Press.

Inc., 1985.

[HS97] J. P. Hansen and M. Sekine. Decision diagram based techniques for the Haar wavelet transform.

In Proc. of the First Int. Conf. on Systems, Communication and Signal Processing, September 1997.

[JBA⁺97] J. Jain, J. Bitner, M. S. Abadir, J. A. Abraham, and D. S. Fussell. Indexed BDDs: Algorithmic advances in techniques to represent and verify Boolean functions. IEEE Trans. on Computers, C-46(11):1230-1245, November 1997.

[LS92] Y. -T. Lai and S. Sastry. Edge-valued binary decision diagrams for multi-level hierarchical verification. In Proc. of the 29th Conf. on Design Automation, pages 608-613, Los Alainitos, Calif., USA, June 1992. IEEE Computer Society Press.

[McM93] K. L. McMillan. Symbolic Model Checking. Kluwer Academic Publishers, 1993.

[QS81] J. P. Quielle and J. Sifakis. Specification and verification of concurrent systems in CESAR.. In Proc. of the Fifth Int. Symp. on Programming, pages 337 350, 1981.

[Ref99] F. Reffel. BDD-nodes can be more expressive. In Proc. of the Asian Computing Science Conference, December 1999.

[SDDS87] J. T. Schwartz, R. B. K. Dewar, E. Dubinsky, and E. Schoenberg. Programming with Sets, An Introduction to SETL. Springer Verlag, 1987.

[SF96] T. Sasao and M. Fujita, editors. Representations of Discrete Functions. Kluwer Academic Publishers, 1996.

[Weg00] I. Wegener. Branching Programs and Binary Decision Diagrams. SIAM Monographs on Disc.

Math. and Appl. Society for Industrial and Applied Mathematics, 2000.

what is claimed is:

1 A method of organizing blocks of memory in a digital computer so as implement an associative memory that, for a given set of Boolean variables, maps Boolean-variable-to-Boolean-value assignments to values stored in the computer memory. Blocks of memory represent instances of class CFLOBDD (CFLOBDDs) and instances of class Grouping (proto-CFLOBDDs) according to the class definitions given in FIG. 12 and Structural Invariants 1-5. The method comprises the following steps:
a. The blocks of memory are connected to form a structure that represents a hierarchically structured graph in which each matched path through the structure (i) corresponds to a unique Boolean-variable-to-Boolean-value assignment, and (ii) leads to an element of the computer memory in which is stored the piece of information associated with that Boolean-variable-to-Boolean-value assignment.

2 The method of claim 1, wherein the connections between blocks of memory are established by the following steps:
a. Create a decision tree that represents the information to be stored in the associative memory, and whose height is an integral power of 2
b. Apply Algorithm 1 to form a multi-terminal CFLOBDD representation in memory.

3 A method for representing groupings and proto-CFLOBDDs in the memory of a computer so that equality of proto-CFLOBDDs can be tested in constant time, comprising the following steps:
a. Allocate a table in which to store the unique representatives of valles of type Grouping.
b. Use the table to perform memoization during operations that construct values of type Grouping in the computer memory, so that only a single representative is ever constructed for each value of type Grouping.
c. Determine whether two values of type Grouping are equal (and hence whether two proto-CFLOBDDs are equal) by testing whether their addresses in the computer memory are equal.
